(19) United States
(12) Patent Application Publication
(10) Pub. No.: US 2025/0387708 A1
(43) Pub. Date: Dec. 25, 2025

(54) EXTERIOR RENDERING

(71) Applicant: Tencent Technology (Shenzhen) Company Limited, Shenzhen (CN)

(72) Inventors: Yumin WANG, Shenzhen (CN); Beichen WANG, Shenzhen (CN)

(73) Assignee: Tencent Technology (Shenzhen) Company Limited, Shenzhen (CN)

(21) Appl. No.: 19/313,393

(22) Filed: Aug. 28, 2025

Related U.S. Application Data
(63) Continuation of application No. PCT/CN2024/087803, filed on Apr. 15, 2024.

(30) Foreign Application Priority Data
Jun. 12, 2023 (CN) 202310687751.4

(51) Int. Cl. A63F 13/57

(52) U.S. Cl. CPC A63F 13/57

(57) ABSTRACT

In an exterior rendering method for a virtual object, a first specular value of a clear coat layer of the virtual object under a light source is determined. The clear coat layer covers an exterior surface of the virtual object. An original reflection value of the exterior surface and a transmittance of the clear coat layer are obtained. A reflection value and a second specular value of the exterior surface under the light source are determined based on the original reflection value and the transmittance. A target illumination value is determined based on the first specular value, the reflection value, and the second specular value. Illumination rendering is performed on an exterior of the virtual object based on the target illumination value.

### RELATED APPLICATIONS

The present application is a continuation of International Application No. PCT/CN2024/087803 filed on Apr. 15, 2024, which claims priority to Chinese Patent Application No. 202310687751.4, filed on Jun. 12, 2023 and entitled “EXTERIOR RENDERING METHOD AND APPARATUS FOR VIRTUAL OBJECT, COMPUTER DEVICE, AND STORAGE MEDIUM”, which are incorporated herein by reference in their entirety.

### FIELD OF THE TECHNOLOGY

This disclosure relates to the field of computer technologies, including to an exterior rendering method and apparatus for a virtual object, a computer device, a storage medium, and a computer program product.

### BACKGROUND OF THE DISCLOSURE

With development of computer technologies, users have increasingly high requirements on an appearance of virtual objects in online games. An exterior is an outside representation of a virtual person, a virtual animal, and a virtual object in an online game. The exterior may be configured for decorating the virtual person, the virtual animal, and the virtual object, to meet a demand for diversified presentation of the virtual person, the virtual animal, and the virtual object.

In the related technology, a material of an exterior is usually cloth, silk, and metal, and diversified exteriors are achieved through different colors, textures, and styles. However, it is difficult to manifest a real texture and a visual effect of the exterior material in the existing manner, resulting in a relatively poor exterior rendering effect of a virtual object.

### SUMMARY

According to various embodiments provided in this disclosure, an exterior rendering method and apparatus for a virtual object, a computer device, a computer-readable storage medium, and a computer program product are provided.

According to an aspect, this disclosure provides an exterior rendering method for a virtual object. In the method, a first specular value of a clear coat layer of the virtual object under a light source is determined. The clear coat layer covers an exterior surface of the virtual object. An original reflection value of the exterior surface and a transmittance of the clear coat layer are obtained. A reflection value and a second specular value of the exterior surface under the light source are determined based on the original reflection value and the transmittance. A target illumination value is determined based on the first specular value, the reflection value, and the second specular value. Illumination rendering is performed on an exterior of the virtual object based on the target illumination value.

According to an aspect, this disclosure provides an information processing apparatus. The information processing apparatus includes processing circuitry that is configured to determine a first specular value of a clear coat layer of a virtual object under a light source. The clear coat layer covers an exterior surface of the virtual object. The processing circuitry is configured to obtain an original reflection value of the exterior surface and a transmittance of the clear coat layer. The processing circuitry is configured to determine a reflection value and a second specular value of the exterior surface under the light source based on the original reflection value and the transmittance. The processing circuitry is configured to determine a target illumination value based on the first specular value, the reflection value, and the second specular value. The processing circuitry is configured to perform illumination rendering on an exterior of the virtual object based on the target illumination value.

According to an aspect, this disclosure provides at least one non-transitory computer-readable storage medium storing instructions which when executed by at least one processor cause the at least one processor to perform any of the exterior rendering methods described herein.

According to an aspect, this disclosure provides an exterior rendering method for a virtual object, which is performed by a terminal, and includes: determining a first highlight value of a varnish layer of a virtual object under a light source, the varnish layer being a varnish material covering an exterior surface layer of the virtual object; obtaining an original reflection value of the exterior surface layer and a transmittance of the varnish layer; determining a reflection value and a second highlight value of the exterior surface layer under the light source based on the original reflection value and the transmittance; determining a target illumination value based on the first highlight value, the reflection value, and the second highlight value; performing illumination rendering on an exterior of the virtual object based on the target illumination value.

According to an aspect, this disclosure provides an exterior rendering apparatus for a virtual object. The apparatus includes: a varnish layer processing module, configured to determine a first highlight value of a varnish layer of a virtual object under a light source, the varnish layer being a varnish material covering an exterior surface layer of the virtual object; an obtaining module, configured to obtain an original reflection value of the exterior surface layer and a transmittance of the varnish layer; an exterior surface layer processing module, configured to determine a reflection value and a second highlight value of the exterior surface layer under the light source based on the original reflection value and the transmittance; a target illumination value determining module, configured to determine a target illumination value based on the first highlight value, the reflection value, and the second highlight value; and a rendering module, configured to perform illumination rendering on an exterior of the virtual object based on the target illumination value.

According to an aspect, this disclosure further provides a computer device. The computer device includes a memory and one or more processors, the memory having computer-readable instructions stored therein, the computer-readable instructions, when executed by the one or more processors, causing the one or more processors to perform the following operations: determining a first highlight value of a varnish layer of a virtual object under a light source, the varnish layer being a varnish material covering an exterior surface layer of the virtual object; obtaining an original reflection value of the exterior surface layer and a transmittance of the varnish layer; determining a reflection value and a second highlight value of the exterior surface layer under the light source based on the original reflection value and the transmittance; determining a target illumination value based on the first highlight value, the reflection value, and the second highlight value; performing illumination rendering on an exterior of the virtual object based on the target illumination value.

According to an aspect, one or more non-volatile readable storage media are provided, having computer-readable instructions stored therein, the computer-readable instructions, when executed by a processor, causing the one or more processors to implement the following operations: determining a first highlight value of a varnish layer of a virtual object under a light source, the varnish layer being a varnish material covering an exterior surface layer of the virtual object; obtaining an original reflection value of the exterior surface layer and a transmittance of the varnish layer; determining a reflection value and a second highlight value of the exterior surface layer under the light source based on the original reflection value and the transmittance; determining a target illumination value based on the first highlight value, the reflection value, and the second highlight value; performing illumination rendering on an exterior of the virtual object based on the target illumination value.

According to an aspect, this disclosure further provides a computer program product, including computer-readable instructions, the computer-readable instructions, when executed by a processor, implementing the following operations: determining a first highlight value of a varnish layer of a virtual object under a light source, the varnish layer being a varnish material covering an exterior surface layer of the virtual object; obtaining an original reflection value of the exterior surface layer and a transmittance of the varnish layer; determining a reflection value and a second highlight value of the exterior surface layer under the light source based on the original reflection value and the transmittance; determining a target illumination value based on the first highlight value, the reflection value, and the second highlight value; performing illumination rendering on an exterior of the virtual object based on the target illumination value.

Details of one or more embodiments of this disclosure are provided in the following drawings and descriptions. Other features, objectives, and advantages of this disclosure become apparent from the specification, the drawings, and the claims.

### BRIEF DESCRIPTION OF THE DRAWINGS

To describe technical solutions in embodiments of this disclosure more clearly, drawings required for describing the embodiments are briefly described below. The drawings described below merely show examples of embodiments of this disclosure. Other embodiments are within the scope of this disclosure.

FIG. 1 is a diagram of an application environment of an exterior rendering method for a virtual object according to an embodiment.

FIG. 2a is a schematic diagram of an exterior rendering method for a virtual object according to an embodiment.

FIG. 2b is a schematic flowchart of an exterior rendering method for a virtual object according to an embodiment.

FIG. 3 is a schematic diagram in which an exterior material is a metal material in the related art.

FIG. 4 is a schematic diagram in which an exterior material is spliced by a metal material and a silk material in the related art.

FIG. 5 is a schematic diagram in which an exterior of a virtual object has a varnish texture from a perspective according to an embodiment.

FIG. 6 is a schematic diagram in which the exterior of the virtual object has a varnish texture from another perspective according to an embodiment.

FIG. 7 is a schematic diagram of an exterior obtained through rendering when no edge adjustment factor is introduced according to an embodiment.

FIG. 8 is a schematic diagram of an exterior obtained through rendering when an edge adjustment factor is introduced according to an embodiment.

FIG. 9 is a schematic diagram in which abnormal stretching occurs in an exterior surface layer covered with a varnish layer according to an embodiment.

FIG. 10 is a schematic diagram in which the abnormal stretching of the exterior surface layer covered with the varnish layer is alleviated according to an embodiment.

FIG. 11 is an overall schematic diagram of an exterior obtained through rendering when an ambient light map is adjusted according to an embodiment.

FIG. 12 is an overall schematic diagram of an exterior obtained through rendering when an ambient light map is adjusted according to an embodiment.

FIG. 13 is a schematic flowchart of an exterior rendering method for a virtual object according to another embodiment.

FIG. 14 is a structural block diagram of an exterior rendering apparatus for a virtual object according to an embodiment.

FIG. 15 is an internal structure diagram of a computer device according to an embodiment.

### DETAILED DESCRIPTION

To make objectives, technical solutions, and advantages of this disclosure clearer, this disclosure is described in further details with reference to drawings and embodiments. The specific embodiments described herein are merely examples for explaining this disclosure, and are not for limiting the scope of this disclosure.

Examples of terms involved in the aspects of the disclosure are briefly introduced. The descriptions of the terms are provided as examples only and are not intended to limit the scope of the disclosure.

In the specification and the drawings, operations and elements that are substantially the same or similar are represented by same or similar reference numerals, and these operations and elements are not repeated. In addition, in the description of this disclosure, terms such as “first” and “second” are merely for a distinguishing purpose, and cannot be understood as indicating or implying relative importance or a sequence.

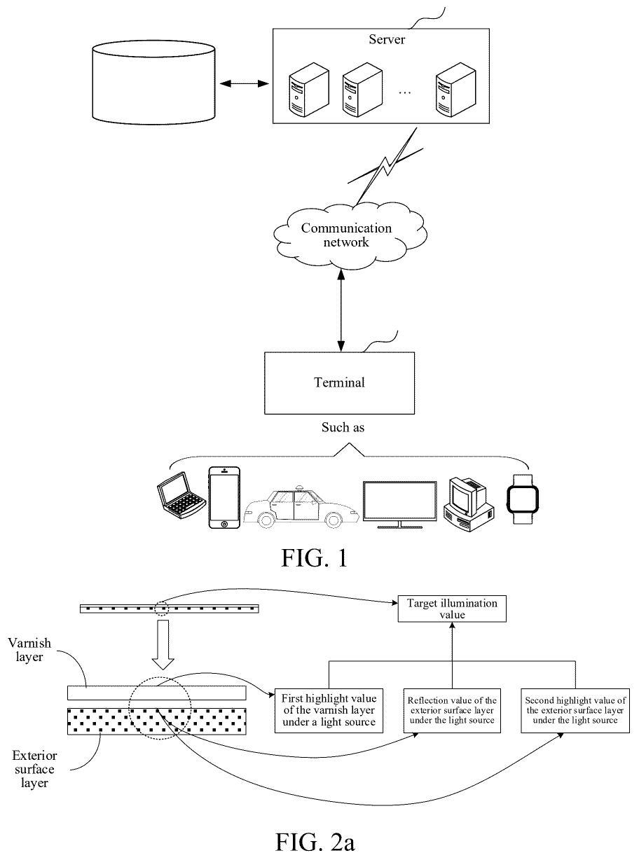

An exterior rendering method for a virtual object provided in the embodiments of this disclosure may be applied to an application environment shown in FIG. 1. A terminal 102 communicates with a server 104 through a network. A data storage system may store data that needs to be processed by the server 104. The data storage system may be integrated in the server 104, or may be deployed on a cloud or another server. The exterior rendering method for a virtual object may be performed by the terminal 102, or may be performed by the server 104, or may be jointly performed by the terminal 102 and the server 104.

An example in which the exterior rendering method for a virtual object is performed by the terminal 102 is used. The terminal 102 may determine a first highlight value (for example, a first specular value) of a varnish layer (for example, a clear coat layer) of a virtual object under a light source, the terminal 102 may obtain an original reflection value of the exterior surface layer and a transmittance of the varnish layer, the terminal 102 may determine a reflection value and a second highlight value of the exterior surface layer under a light source based on the original reflection value and the transmittance, the terminal 102 may determine a target illumination value based on the first highlight value, the reflection value, and the second highlight value, and the terminal 102 may further perform illumination rendering on the exterior of the virtual object based on the target illumination value.

The terminal 102 may be a smartphone, a tablet computer, a notebook computer, a desktop computer, a smart speaker, a smart watch, an Internet of Things device, and a portable wearable device. The Internet of Things device may be a smart speaker, a smart television, a smart air conditioner, a smart on-board device, or the like. The portable wearable device may be a smart watch, a smart bracelet, a head-mounted device, or the like.

The server 104 may be an independent physical server, or may be a serving node in a blockchain system. A peer to peer (P2P) network is formed between serving nodes in the blockchain system. A P2P protocol is an application-layer protocol running over a transmission control protocol (TCP).

Alternatively, the server 104 may be a server cluster including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

The terminal 102 and the server 104 may be connected through a communicative connection such as a Bluetooth, a USB (Universal Serial Bus), or a network, which is not limited in this disclosure.

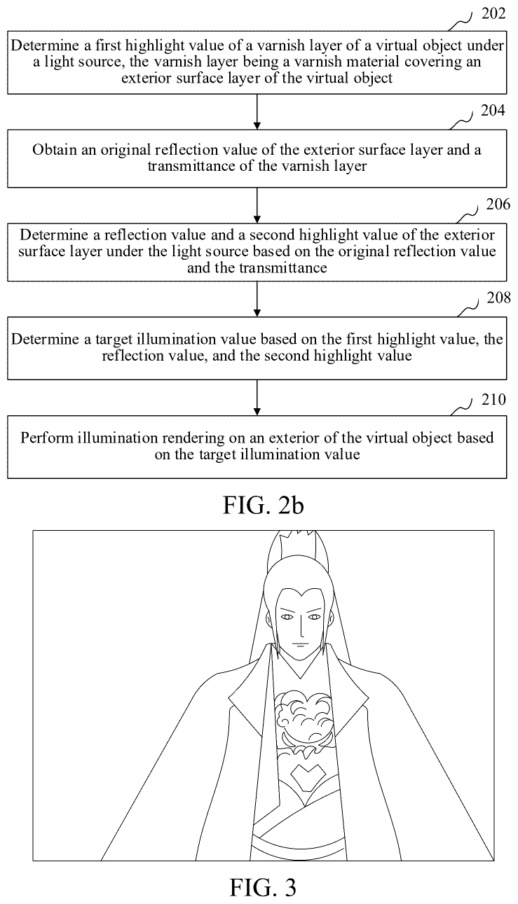

In an embodiment, as shown in FIG. 2a and FIG. 2b, an exterior rendering method for a virtual object is provided. The method may be performed by the terminal or the server in FIG. 1, or may be performed jointly by the terminal and the server in FIG. 1. A description is provided by using an example in which the method is performed by the terminal in FIG. 1. The method includes the following operations:

Operation 202: Determine a first highlight value of a varnish layer of a virtual object under a light source, the varnish layer being a varnish material covering an exterior surface layer of the virtual object. In an example, a first specular value of a clear coat layer of the virtual object under a light source is determined. The clear coat layer covers an exterior surface of the virtual object.

The virtual object is different from a real object. The virtual object is a virtualized role image. For example, the virtualized role image may be a player role image in a virtual scene that represents a user and controlled by the user, or may be a non-player role image in a virtual scene that represents a user and that can interact with the user. For example, the virtual object may be a virtual person or a virtual animal. The virtual object may alternatively be another virtual object in a virtual scene. For example, the virtual object may be a virtual building part (such as a table, a chair, a door, or a window) or a virtual vehicle (such as a vehicle or a watercraft).

The virtual scene may be a scene virtualized from a real environment through simulation. For example, the virtual scene may include a virtual sky, a virtual river, a virtual mountain, a virtual animal and plant, or a virtual building. The virtual scene may be displayed in real time when the terminal runs a game application.

The exterior refers to an outside equipment of the virtual object, which includes but is not limited to costumes, props, and ornaments. In an actual application, the exterior of the virtual object in the virtual scene may be obtained through purchase or activity participation, and the exterior of the virtual object may be changed to change an image of the virtual object. For example, when the virtual object represents a player role image of a user, the exterior of the virtual object may be a costume of the virtual object, and the costume of the virtual object may be changed to change the player role image of the user. When the virtual object is a virtual vehicle in the virtual scene, an ornament of the virtual vehicle may be changed, to change an image of the virtual vehicle.

The exterior surface layer is a surface layer of the exterior, and a display style of the exterior is related to a material of the exterior surface layer. The material of the exterior surface layer includes but is not limited to a metal material, a leather material, and a cloth material, or may be a material spliced by at least two of the metal material, the leather material, and the cloth material. For example, the exterior of the virtual object includes an armor, and a surface material of the armor is spliced by a metal material and a leather material. In this case, a display style of the armor is related to the metal material and the leather material.

The varnish layer covers the exterior surface layer. Adding the varnish layer to the exterior surface layer brings a varnish texture to the exterior in terms of a visual effect. Varnish is a paint. The varnish is applied to a material, to form, on the material, a transparent varnish film that can display an original texture of the material, so that the exterior has a varnish texture. The varnish texture may mean that the exterior covered with the varnish has a bright visual effect, and can present a sparkling effect during changing of a visual angle.

The light source may be a direct light source. Light emitted by the direct light source is from a light source in the virtual scene. The direct light source is different from an indirect light source, and light emitted by the indirect light source is from an object in the virtual scene.

The light source in the virtual scene includes, but is not limited to, a parallel light source and a point light source. The parallel light source may be configured for simulating the sun or the moon, and a position of the point light source in the virtual scene may be a position of a camera model.

The camera model can automatically follow the virtual object in the virtual scene. When the position of the virtual object in the virtual scene changes, the position of the camera model changes with the position of the virtual object in the virtual environment. The camera model may be located at a rear of the virtual object by default, and the virtual object in the virtual scene may be observed through the camera model from different angles. For example, a viewing angle may be changed to switch from observing the virtual object from the rear of the virtual object to observing the virtual object from a side of the virtual object.

The first highlight value refers to a highlight value generated on the varnish layer by the light emitted by the light source, and may be configured for manifesting a degree of specular reflection of the varnish layer for the light emitted by the light source.

In some embodiments, for the varnish layer covering the exterior surface layer of the virtual object, the terminal obtains a varnish layer roughness, determines a reflection roughness and a visibility of the varnish layer based on the varnish layer roughness, and determines the first highlight value of the varnish layer under the light source based on the reflection roughness and the visibility of the varnish layer. The reflection roughness can manifest a reflection effect of the varnish layer for the light, and the visibility can manifest a degree of blocking of light by the varnish layer. Calculating the first highlight value in combination with the reflection roughness and the visibility of the varnish layer can improve accuracy of the first highlight value.

In some embodiments, the light source is a direct light source, and the terminal may determine the first highlight value of the varnish layer under the direct light source based on the reflection roughness and the visibility of the varnish layer. The first highlight value is a first highlight value of a to-be-rendered position of the virtual object on the varnish layer. The to-be-rendered position is a position on the exterior of the virtual object, and the to-be-rendered position may be described through a coordinate system of the virtual scene. Different to-be-rendered positions may have different first highlight values on the varnish layer, and therefore different to-be-rendered positions on the varnish layer have different degrees of specular reflection for the light, so that a rendered varnish layer has an uneven presentation effect.

Operation 204: Obtain an original reflection value of the exterior surface layer and a transmittance of the varnish layer. In an example. an original reflection value of the exterior surface and a transmittance of the clear coat layer are obtained.

The original reflection value is a reflection value of the exterior surface layer, namely, a reflection value of the exterior surface layer of the exterior surface layer not covered with the varnish layer. When the material of the exterior surface layer is a specular material, the original reflection value may be an original reflection value generated from specular reflection. When the material of the exterior surface layer is not a specular material, the original reflection value may be an original reflection value generated from diffuse reflection.

The original reflection value of the exterior surface layer is an original reflection value of the to-be-rendered position on the exterior surface layer. Different to-be-rendered positions may have different original reflection values on the exterior surface layer. For example, because a texture is an effect presented when different roughnesses exist, and different to-be-rendered positions, which have different roughness, have different light reflect conditions on the exterior surface layer, when the material of the exterior surface layer includes a texture, different to-be-rendered positions have different original reflection values on the exterior surface layer. For example, when the material of the exterior surface layer is spliced by a specular material and a non-specular material, different to-be-rendered positions may have different reflection conditions on the exterior surface layer, and therefore different to-be-rendered positions have different original reflection values on the exterior surface layer.

The transmittance of the varnish layer is a transmittance of the to-be-rendered position on the varnish layer. When the light emitted by the light source penetrates the varnish layer, the light is absorbed by the varnish layer medium, causing light attenuation. The transmittance of the varnish layer is configured for describing a degree of attenuation after the light penetrates the varnish layer. An optical effect of the light penetrating the varnish layer may be simulated through the transmittance.

In some embodiments, the terminal obtains the original reflection value of the exterior surface layer. The original reflection value of the exterior surface layer may be determined based on the material of the exterior surface layer. A specific value of the original reflection value of the exterior surface layer is not limited in this embodiment of this disclosure. The terminal may obtain the transmittance of the varnish layer based on a thickness, a metalness, and a color pixel value of the varnish layer. The terminal obtains the original reflection value of the exterior surface layer and the transmittance of the varnish layer, so as to subsequently determine a reflection value and a second highlight value of the exterior surface layer covered with the varnish layer, so that the reflection value and the second highlight value are related to the degree of attenuation after the light penetrates the varnish layer, thereby improving accuracy of the reflection value and the second highlight value of the exterior surface layer.

The obtained original reflection value and transmittance correspond to the same to-be-rendered position. To be specific, the terminal obtains the original reflection value of the to-be-rendered position on the exterior surface layer and obtains the transmittance of the to-be-rendered position on the varnish layer.

Operation 206: Determine a reflection value and a second highlight value of the exterior surface layer under the light source based on the original reflection value and the transmittance. In an example, a reflection value and a second specular value of the exterior surface under the light source are determined based on the original reflection value and the transmittance.

The reflection value of the exterior surface layer under the light source is a reflection value of the exterior surface layer when the exterior surface layer is covered with the varnish layer. The second highlight value is a highlight value generated on the exterior surface layer after the light emitted by the light source penetrates the varnish layer.

Because the original reflection value and the transmittance correspond to the same to-be-rendered position, the determined reflection value is a reflection value of the to-be-rendered position on the exterior surface layer, and the determined second highlight value is a second highlight value of the to-be-rendered position on the exterior surface layer.

In some embodiments, the terminal determines the reflection value of the exterior surface layer based on the original reflection value, a reflection intensity of the varnish layer, and the transmittance, and the terminal determines a second Fresnel factor of the exterior surface layer, and determines the second highlight value based on the second Fresnel factor and the transmittance. The second Fresnel factor is configured for manifesting a ratio between a light reflection intensity and a light transmission intensity when the light passes through interfaces of two media. A light intensity of the light emitted by the light source after penetrating the varnish layer may be determined based on the second Fresnel factor and the transmittance, and the second highlight value of the exterior surface layer may be determined based on the light intensity of the light emitted by the light source after penetrating the varnish layer, so that the second highlight value is related to the light intensity of the light after penetrating the varnish layer and the degree of attenuation of the light after penetrating the varnish layer, thereby improving accuracy of the second highlight value.

In some embodiments, the light source is a direct light source, and the terminal may determine, based on the original reflection value and the transmittance, the reflection value and the second highlight value of the original exterior layer under the light that is emitted by the direct light source and that penetrates the varnish layer, so that the reflection value may be configured for representing a reflection value of the exterior surface layer for the light that is emitted by the direct light source and that penetrates the varnish layer, and the second highlight value may be configured for representing a highlight value generated on the exterior surface layer by the light that is emitted by the direct light source and that penetrates the varnish layer, so as to subsequently render a display effect of the exterior surface layer under the direct light source based on the reflection value and the second highlight value.

Operation 208: Determine a target illumination value based on the first highlight value, the reflection value, and the second highlight value. In an example, a target illumination value is determined based on the first specular value, the reflection value, and the second specular value.

The target illumination value is a target illumination value of the to-be-rendered position on the exterior of the virtual object.

In some embodiments, the first highlight value is an illumination value of the varnish layer. The terminal performs linear processing on the reflection value and the second highlight value to obtain an illumination value of the exterior surface layer, and performs linear processing on the illumination value of the varnish layer and the illumination value of the exterior surface layer to obtain the target illumination value. The first highlight value, the reflection value, and the second highlight value correspond to the same to-be-rendered position on the exterior of the virtual object. The target illumination value is determined in combination with the illumination values of the varnish layer and the exterior surface layer, so that the target illumination value can manifest a comprehensive illumination value of the varnish layer and the exterior surface layer. Therefore, rendering may be performed based on the target illumination value, to obtain a visual effect generated from superposition of the varnish layer and the exterior surface layer, so that the exterior has a varnish texture.

In some embodiments, performing the linear processing on the reflection value and the second highlight value, to obtain the illumination value of the exterior surface layer may be adding the reflection value and the second highlight value together, to obtain the illumination value of the exterior surface layer, or may be obtaining, by the terminal, a reflection weight and a highlight weight, and performing weighted summation on the reflection value and the second highlight value based on the reflection weight and the highlight weight, to obtain the illumination value of the exterior surface layer. Adding the reflection value and the second highlight value together can reduce hardware resources required for determining the illumination value of the exterior surface layer, and improve rendering efficiency. The weighted summation is performed on the reflection value and the second highlight value, so that the illumination value of the exterior surface layer can bias to one of the reflection value and the second highlight value with a higher weight, thereby highlighting an illumination effect brought by the reflection value or the second highlight value with the higher weight.

In some embodiments, performing the linear processing on the illumination value of the varnish layer and the illumination value of the exterior surface layer, to obtain the target illumination value may be adding the illumination value of the varnish layer and the illumination value of the exterior surface layer together, to obtain the target illumination value. Alternatively, the terminal obtains an illumination weight of the varnish layer and an illumination weight of the exterior surface layer, and performs weighted summation on the illumination value of the varnish layer and the illumination value of the exterior surface layer based on the illumination weight of the varnish layer and the illumination weight of the exterior surface layer, to obtain the target illumination value. Adding the illumination value of the varnish layer and the illumination value of the exterior surface layer together can reduce the hardware resources required for determining the target illumination value, and improve the rendering efficiency. The weighted summation is performed on the illumination value of the varnish layer and the illumination value of the exterior surface layer, so that the target illumination value can bias to one of the illumination value of the varnish layer and the illumination value of the exterior surface layer with a higher weight, to highlight an illumination effect of the varnish layer or the exterior surface layer with the higher weight.

For example, the first highlight value of the to-be-rendered position on the varnish layer, the reflection value on the exterior surface layer, and the second highlight value are added together, to obtain the target illumination value of the to-be-rendered position.

Operation 210: Perform illumination rendering on an exterior of the virtual object based on the target illumination value. In an example, illumination rendering is performed on an exterior of the virtual object based on the target illumination value.

In some embodiments, the terminal may perform rendering in a high-definition rendering pipeline based on the target illumination value through an illumination shader. The target illumination value is a target illumination value of the to-be-rendered position on the exterior of the virtual object. The illumination shader may calculate a color pixel value based on the target illumination value, and display the color pixel value to implement rendering. The illumination rendering is performed on the exterior of the virtual object based on the target illumination value, so that the highlight effect on the varnish layer and the reflection effect and the highlight effect on the exterior surface layer can be superposed, to obtain the visual effect of the exterior surface layer covered with the varnish layer. Therefore, the exterior surface layer has a varnish texture, thereby improving the visual effect.

Because the target illumination value is a target illumination value of the to-be-rendered position on the exterior of the virtual object, the terminal may perform rendering in the high-definition rendering pipeline based on a target illumination value of each to-be-rendered position on the exterior through the illumination shader, to obtain a target exterior surface layer. The target exterior surface layer is obtained through covering of the varnish layer with the exterior surface layer. The target illumination value is determined based on the first highlight value, the reflection value, and the second highlight value. The rendering is performed based on the target illumination value, so that the highlight effect on the varnish layer and the reflection effect and the highlight effect on the exterior surface layer can be superposed, to obtain an effect of the exterior surface layer covered with the varnish layer.

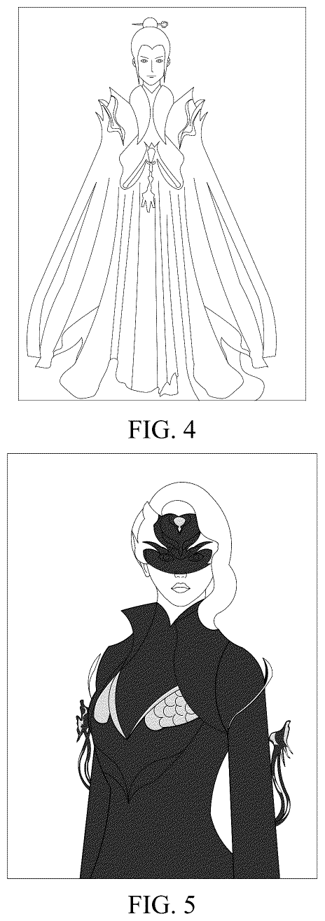

For example, referring to FIG. 3 and FIG. 4, in the related technology, an exterior display style of a virtual object is related to only an exterior surface layer. For example, in FIG. 3, a surface material of an exterior (an armor) of a virtual object is a metal material. In this case, a display style of the armor in FIG. 3 is related to only the metal material. In FIG. 4, a surface material of an exterior (a costume) of a virtual object is spliced by a metal material and a silk material. In this case, a display style of the costume in FIG. 4 is related to only the metal material and the silk material.

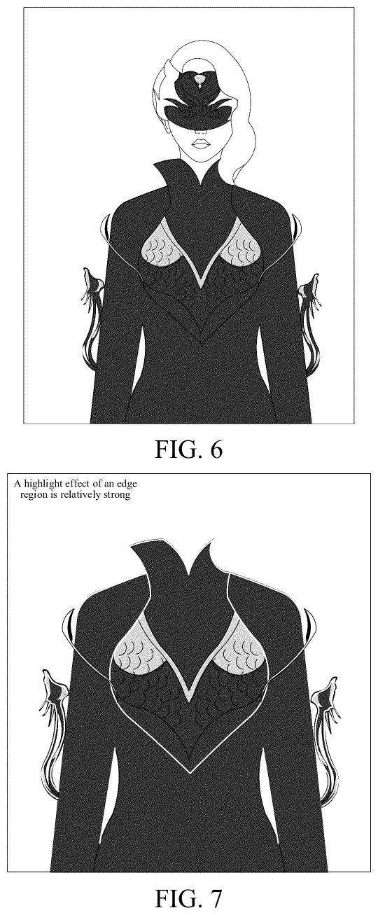

FIG. 5 is a display effect of an exterior surface layer covered with a varnish layer from a perspective according to an embodiment of this disclosure. FIG. 6 is a display effect of the exterior surface layer covered with the varnish layer from another perspective according to an embodiment of this disclosure. It may be learned that in FIG. 5 and FIG. 6, an armor (including a breastplate and a pauldron) and a mask of a virtual object both have a varnish texture. Compared with the display effect of the exterior in the related technology, in this embodiment of this disclosure, the rendered exterior can better present a real texture of the exterior material, thereby improving a visual effect.

In the foregoing exterior rendering method for a virtual object, for the varnish layer covering the exterior surface layer, the first highlight value of the varnish layer under the light source is determined, the reflection value and the second highlight value of the exterior surface layer under the light source are determined based on the original reflection value and the transmittance, the target illumination value is determined based on the first highlight value, the reflection value, and the second highlight value, and the illumination rendering is performed on the exterior of the virtual object based on the target illumination value, which can implement superposition of the highlight effect on the varnish layer and the reflection effect and the highlight effect on the exterior surface layer, to obtain the visual effect of the exterior surface layer covered with the varnish layer, so that the exterior surface layer has a varnish texture, thereby improving the visual effect.

In some embodiments, the light source is a direct light source, and the determining a first highlight value of a varnish layer of a virtual object under a light source includes: determining a reflection roughness of the varnish layer based on a varnish layer roughness of the virtual object and a first normal vector and a first half-way vector of the varnish layer; determining a visibility of the varnish layer based on the varnish layer roughness, the first normal vector, a first line-of-sight direction vector of the varnish layer, and a light source direction vector of the direct light source; and determining the first highlight value of the varnish layer under the direct light source based on the reflection roughness, the visibility, and the reflection intensity of the varnish layer. Determining the first highlight value of the varnish layer in combination with the reflection roughness and the visibility of the varnish layer can improve accuracy of the first highlight value.

The varnish layer roughness is a roughness of the to-be-rendered position on the varnish layer. When a varnish layer roughness of a different to-be-rendered positions varies, a reflection effect of the different to-be-rendered position for light also varies, which affects a first highlight value of the to-be-rendered position. A rougher varnish layer (a larger varnish layer roughness) indicates a darker highlight effect (a smaller first highlight value), and a smoother varnish layer (a smaller varnish layer roughness) indicates a brighter highlight effect (a larger first highlight value).

The first normal vector of the varnish layer is a first normal vector of the to-be-rendered position on the varnish layer. The first normal vector of the to-be-rendered position affects the first highlight value of the to-be-rendered position. When a first normal vector of a different candidate position varies, a first highlight value of the different to-be-rendered position also varies, so that the varnish layer has an uneven feeling. For example, the first normal vector may be set, so that the varnish layer has a scratch, dent, or protrusion effect.

The light source direction vector of the direct light source is a direction vector configured for representing a direction vector of the light emitted by the direct light source illuminated on the varnish layer, which may also be referred to as a light source direction vector of the varnish layer.

The first half-way vector of the varnish layer is an intermediate vector between the light source direction vector and the first line-of-sight direction vector of the varnish layer, the light source direction vector of the varnish layer is a vector on the varnish layer from the to-be-rendered position to the direct light source, and the first line-of-sight direction vector is a vector on the varnish layer from the to-be-rendered position to the camera model.

The varnish layer roughness causes an uneven varnish layer may be understood as that the varnish layer includes many micro surfaces and light is specularly reflected or refracted on each micro surface. That the light is reflected or refracted on the varnish layer actually means that specular reflection or refraction occurs on the micro surface corresponding to the first normal vector. A probability distribution of the first normal vector conforms to a micro surface distribution function. The reflection roughness of the varnish layer can manifest a distribution condition of the first normal vectors of the micro surfaces on the varnish layer, and may further reflect the reflection effect of the varnish layer for the light. A lower reflection roughness indicates a reflection effect of the varnish layer closer to specular reflection, and a higher reflection roughness indicates a stronger diffuse reflection effect of the varnish layer.

When the light is reflected on the varnish layer, the micro surface of the varnish layer may block incident light and emergent light. The visibility of the varnish layer can manifest a degree of blocking of the light by the micro surface of the varnish layer. A higher visibility indicates a higher degree of blocking of the light by the micro surface of the varnish layer, and a lower visibility indicates a lower degree of blocking of the light by the micro surface of the varnish layer. The degree of blocking of the light by the micro surface on the varnish layer may further affect a degree of reflection of the light on the varnish layer. A lower visibility indicates a lower degree of reflection of the light on the varnish layer, and a higher visibility indicates a higher degree of reflection of the light on the varnish layer.

The reflection intensity of the varnish layer is configured for manifesting a specular reflection effect of the varnish layer. A larger reflection intensity of the varnish layer indicates a stronger specular reflection effect of the varnish layer, and a smaller reflection intensity of the varnish layer indicates a weaker specular reflection effect of the varnish layer.

In some embodiments, the terminal obtains a varnish layer roughness, a first normal vector, and a first half-way vector of the to-be-rendered position on the varnish layer, and determines a normal distribution of the micro surface corresponding to the to-be-rendered position in the varnish layer based on the varnish layer roughness, the first normal vector, and the first half-way vector of the to-be-rendered position on the varnish layer, so as to obtain a reflection roughness of the to-be-rendered position on the varnish layer; determines a visibility of the to-be-rendered position on the varnish layer based on the varnish layer roughness of the to-be-rendered position on the varnish layer, the first normal vector, the first line-of-sight direction vector, and the light source direction vector of the varnish layer; and determines a reflectivity of the to-be-rendered position on the varnish layer based on the reflection roughness and the visibility of the to-be-rendered position on the varnish layer, and determines the first highlight value of the varnish layer under the direct light source based on the reflectivity and the reflection intensity of the to-be-rendered position on the varnish layer.

In some embodiments, before the determining a reflection roughness of the varnish layer based on a varnish layer roughness of the virtual object and a first normal vector and a first half-way vector of the varnish layer, the method further includes: obtaining a roughness map of the varnish layer, and obtaining the varnish layer roughness from the roughness map; and obtaining a first normal map of the varnish layer, and obtaining the first normal vector from the first normal map.

Specifically, the roughness map has a varnish layer roughness of each to-be-rendered position on the varnish layer stored therein. After obtaining the roughness map of the varnish layer, the terminal may obtain the varnish layer roughness of each to-be-rendered position on the varnish layer from the roughness map. The first normal map has a first normal vector of each to-be-rendered position on the varnish layer stored therein. After obtaining the first normal map, the terminal may obtain the first normal vector of each to-be-rendered position on the varnish layer from the first normal map. The roughness map and the first normal map may be customized, to achieve a display effect of the varnish layer. For example, the roughness map and the first normal map may be designed based on a display demand for the varnish layer, to produce a reflection effect, a scratch effect, and a dent effect of the varnish layer.

In the foregoing embodiment, the specular reflection effect of the light on the varnish layer may be obtained through determining of the reflection roughness of the varnish layer, the degree of blocking of the light on the varnish layer may be obtained through determining of the visibility of the varnish layer, and the accuracy of the first highlight value may be improved through determining of the first highlight value of the varnish layer in combination with the reflection roughness and the visibility of the varnish layer.

In some embodiments, the determining a reflection roughness of the varnish layer based on a varnish layer roughness of the virtual object and a first normal vector and a first half-way vector of the varnish layer, the method further includes: determining a roughness factor based on the varnish layer roughness of the virtual object; fusing the first normal vector and the first half-way vector of the varnish layer, to obtain a first fusion result; and determining the reflection roughness of the varnish layer based on the roughness factor and the first fusion result. The reflection roughness of the varnish layer is determined based on the varnish layer roughness. The reflection roughness can manifest a reflection effect of the light on the varnish layer, so that the reflection effect of the varnish layer conforms to a real texture of the varnish layer.

In some embodiments, the terminal calculates a square of the reflection roughness, to obtain a candidate roughness factor, and calculates a square of the candidate roughness factor, to obtain a roughness factor. In an actual application, the roughness factor may be a value between 0 and 1. Fusing, by the terminal, the first normal vector and the first half-way vector of the varnish layer may be performing dot multiplication on the first normal vector and the first half-way vector. For example, the first fusion result is TopNdH. TopNdH=dot (N1, H1), N1 being the first normal vector, and H1 being the first half-way vector.

The terminal determines a first product of the roughness factor and the first fusion result, determines a first difference between the first product and the first fusion result, determines a second product of the first difference and the first fusion result, and determines a candidate roughness factor through the second product. The terminal calculates a square of the candidate roughness factor, and determines a ratio of the roughness factor to the square of the candidate roughness factor, to obtain the reflection roughness of the varnish layer.

Because the roughness factor is a roughness factor of the to-be-rendered position on the varnish layer, and the first normal vector and the first half-way vector are the first normal vector and the first half-way vector of the to-be-rendered position on the varnish layer, the first fusion result is a first fusion result corresponding to the to-be-rendered position on the varnish layer, and the reflection roughness of the varnish layer is a reflection roughness of the to-be-rendered position on the varnish layer. A reflection roughness of each to-be-rendered position on the exterior of the virtual object on the varnish layer may be determined in the foregoing manner. Because the reflection roughness is determined based on the first normal vector and the first half-way vector of the to-be-rendered position, a rendering scale is refined to a pixel scale of the to-be-rendered position, which can achieve a more real varnish texture.

In some embodiments, the terminal may process the roughness factor and the first fusion result through a GGX distribution function in a physically-based rendering (PBR) illumination model, to determine the reflection roughness of the varnish layer. PBR is a physical rendering technology, and a GGX distribution is a Trowbridge-Reitz distribution, which may be configured for rendering specular reflection. Because the reflection roughness of the varnish layer on the micro surface of the varnish layer is determined through the GGX distribution function, the reflection roughness can manifest a reflection effect of the micro surface of the varnish layer for the light. Directly determining the reflection roughness through the GGX distribution function can reduce a duration required for determining the reflection roughness and improve the rendering efficiency.

In the foregoing embodiment, the first normal vector and the first half-way vector of the varnish layer are fused, and the reflection roughness of the varnish layer is determined based on the first fusion result obtained through fusion and the roughness factor. The reflection roughness can manifest a reflection effect of the light on the varnish layer, so that the reflection effect of the varnish layer conforms to a real texture of the varnish layer. Subsequently, the first highlight value is determined based on the reflection roughness of the varnish layer, so that the first highlight value can manifest a degree of specular reflection of the varnish layer for the light.

In some embodiments, the determining a visibility of the varnish layer based on the varnish layer roughness, the first normal vector, a first line-of-sight direction vector of the varnish layer, and a light source direction vector of the direct light source includes: determining a roughness factor based on the varnish layer roughness of the virtual object; fusing the first normal vector and the first line-of-sight direction vector of the varnish layer, to obtain a second fusion result; fusing the first normal vector and the light source direction vector of the direct light source, to obtain a third fusion result; determining a visibility of the varnish layer in a line-of-sight direction and a visibility of the varnish layer in a light source direction based on the roughness factor, the second fusion result, and the third fusion result; determining the visibility of the varnish layer based on the visibility in the line-of-sight direction and the visibility in the light source direction. The visibility of the varnish layer is determined based on the varnish layer roughness, so that the visibility can manifest the degree of blocking of the light by the varnish layer, and can further reflect the reflection effect of the light on the varnish layer, so that the reflection effect of the varnish layer for the light conforms to the real texture of the varnish layer.

In some embodiments, the terminal calculates a square of the reflection roughness, to obtain a candidate roughness factor, and calculates a square of the candidate roughness factor, to obtain a roughness factor. In an actual application, the roughness factor may be a value between 0 and 1.

The terminal performs dot multiplication on the first normal vector and the first line-of-sight direction vector, to obtain a second fusion result. For example, the second fusion result is TopNdV. TopNdV=dot (N1, V1), N1 being the first normal vector, and V1 being the first line-of-sight direction vector. The terminal performs dot multiplication on the first normal vector and the light source direction vector of the varnish layer, to obtain a third fusion result. For example, the third fusion result is TopNdL. TopNdL=dot (N1, L1), N1 being the first normal vector, and L1 being the light source direction vector of the varnish layer.

After obtaining the roughness factor, the terminal may process the roughness factor, the second fusion result, and the third fusion result in a first fusion manner, to obtain a visibility of the varnish layer in a line-of-sight direction; and process the roughness factor, the second fusion result, and the third fusion result in a second fusion manner, to obtain a visibility of the varnish layer in a light source direction.

The first fusion manner is different from the second fusion manner. In the first fusion manner, a first intermediate result may be determined based on the roughness factor and the second fusion result, and then the first intermediate result and the third fusion result are fused, to obtain the visibility of the varnish layer in the line-of-sight direction. In the second fusion manner, a second intermediate result may be determined based on the roughness factor and the third fusion result, and then the second intermediate result and the second fusion result are fused, to obtain the visibility of the varnish layer in the light source direction.

The terminal determines a sum of the visibility in the line-of-sight direction and the visibility in the light source direction, to obtain a candidate visibility, and determines a ratio of a reference factor to the candidate visibility, to obtain the visibility of the varnish layer. In an actual application, the reference factor may be 0.5.

The roughness factor, the second fusion result, and the third fusion result are the reflection roughness of the to-be-rendered position on the varnish layer, and the visibility of the varnish layer is the visibility of the to-be-rendered position on the varnish layer. A visibility of each to-be-rendered position on the exterior of the virtual object on the varnish layer may be determined in the foregoing manner. The visibility is determined based on the roughness factor, the second fusion result, and the third fusion result of the to-be-rendered position, so that a rendering scale is refined to a pixel scale of the to-be-rendered position, which can achieve a more real varnish texture.

In some embodiments, the determining a visibility of the varnish layer in a line-of-sight direction and a visibility of the varnish layer in a light source direction based on the roughness factor, the second fusion result, and the third fusion result includes: determining a second difference between the initial factor and the roughness factor; determining a third product of the second difference and the second fusion result, and determining a fourth product of the third product and the roughness factor; determining a product of the fourth product and the third fusion result, to obtain the visibility of the varnish layer in the line-of-sight direction; and determining the visibility of the varnish layer in the light source direction based on the roughness factor, the second difference, the second fusion result, and the third fusion result. Because the visibility of the varnish layer in the light source direction is determined through the initial factor, the roughness factor, the second fusion result, and the third fusion result, accuracy of a degree of blocking of the light by the varnish layer in the light source direction is improved, so that the reflection effect of the varnish layer for the light conforms to the real texture of the varnish layer.

The terminal calculates a second difference by subtracting the roughness from an initial factor, multiplies the second difference by the second fusion result, to obtain a third product, multiplies the third product by the roughness factor, to obtain a fourth product, and multiplies the fourth product by the third fusion result, to obtain the visibility of the varnish layer in the line-of-sight direction. In an actual application, the initial factor may be set as required. For example, the initial factor may be 1.

In some embodiments, the determining the visibility of the varnish layer in the light source direction based on the roughness factor, the second difference, the second fusion result, and the third fusion result includes: determining a fifth product of the second difference and the third fusion result; determining a sixth product of the roughness factor and the fifth product; and determining a product of the sixth product and the second fusion result, to obtain the visibility of the varnish layer in the light source direction. Because the visibility of the varnish layer in the light source direction is determined through the initial factor, the roughness factor, the second fusion result, and the third fusion result, accuracy of a degree of blocking of the light by the varnish layer in the light source direction is improved, so that the reflection effect of the varnish layer for the light conforms to the real texture of the varnish layer.

In some embodiments, the terminal may process the roughness factor, the second fusion result, and the third fusion result through a Smith function in the PBR illumination model, to obtain the visibility of the varnish layer. The Smith function is a masking function, and may be configured to determine degrees of blocking of the incident light and the emergent light by the micro surface on the varnish layer, so as to determine the visibility. Because the visibility of the varnish layer on the micro surface of the varnish layer is determined through the Smith function, the visibility can manifest the degree of blocking of the light by the micro surface of the varnish layer. Directly determining the visibility through the Smith function can reduce a duration required for determining the visibility and improve the rendering efficiency.

In the foregoing embodiment, the first normal vector and the first line-of-sight direction vector of the varnish layer are fused, to obtain the second fusion result, the first normal vector and the light source direction vector of the varnish layer are fused, to obtain the third fusion result, and the visibility of the varnish layer is determined based on the roughness factor, the second fusion result, and the second fusion result, so that the visibility can manifest the degree of blocking of the light by the varnish layer, and can manifest the reflection effect of the light on the varnish layer, the reflection effect of the varnish layer for the light conforms to the real texture of the varnish layer. Subsequently, the first highlight value is determined based on the visibility of the varnish layer, o that the first highlight value can manifest the degree of specular reflection of the varnish layer for the light.

In some embodiments, the determining the first highlight value of the varnish layer under the direct light source based on the reflection roughness, the visibility, and the reflection intensity of the varnish layer includes: determining a reflectivity of the varnish layer based on the reflection roughness, the visibility, and a first Fresnel factor of the varnish layer; and determining the first highlight value of the varnish layer under the direct light source based on the reflectivity of the varnish layer and the reflection intensity of the varnish layer. The first Fresnel factor is introduced, so that an incident angle of the light affects the reflectivity, thereby improving accuracy of the first highlight value determined based on the reflectivity.

The first Fresnel factor is a Fresnel factor of the to-be-rendered position on the varnish layer. The first Fresnel factor is configured for manifesting reflection intensities of the light at different incident angles. When the incident angle is relatively large, the varnish layer performs specular reflection on the light. When the incident angle is relatively small, the varnish layer diffuses the light. During actual rendering, the varnish layer may diffuse the light to display a rough effect.

In some embodiments, the terminal fuses the first normal vector and the light source direction vector of the varnish layer, to obtain a third fusion result; and determines a product of the reflection roughness, the visibility, and the first Fresnel factor of the varnish layer, to obtain the reflectivity of the varnish layer; and determines a product of the reflection intensity, the third fusion result, and the reflectivity of the varnish layer, to obtain the first highlight value of the varnish layer under the direct light source.

The first Fresnel factor is a Fresnel factor of the to-be-rendered position on the varnish layer, the reflectivity of the varnish layer determined based on the first Fresnel factor is the Fresnel factor of the to-be-rendered position on the varnish layer, and the first highlight value is the first highlight value of the to-be-rendered position on the varnish layer. The first highlight value of each to-be-rendered position on the exterior of the virtual object on the varnish layer may be determined in the foregoing manner.

In the foregoing embodiment, the reflectivity of the varnish layer is determined based on the reflection roughness, the visibility, and the first Fresnel factor of the varnish layer, and then the first highlight value is determined based on the reflectivity of the varnish layer. The first Fresnel factor is introduced, so that the incident angle of the light ray affects the reflectivity, thereby improving the accuracy of the first highlight value determined based on the reflectivity.

In some embodiments, the light source includes a direct light source, and the determining a reflection value and a second highlight value of the exterior surface layer under the light source based on the original reflection value and the transmittance includes: determining, based on the original reflection value, the transmittance, and the reflection intensity of the varnish layer, a reflection value of the exterior surface layer for reflecting direct transmission light, the direct transmission light being light that is emitted by the direct light source and that is transmitted through the varnish layer; determining a second Fresnel factor of the exterior surface layer based on a second line-of-sight direction vector of the exterior surface layer, a second half-way vector, and a reflectivity corresponding to a second normal vector; and determining, based on the transmittance and the second Fresnel factor, the second highlight value generated on the exterior surface layer by the direct transmission light. Because the reflection value of the exterior surface layer covered with the varnish layer is determined in combination with the original reflection value, the transmittance, and the reflection intensity, the accuracy of the reflection value is improved. The second Fresnel factor is configured for manifesting a ratio between a light reflection intensity and a light transmission intensity when the light passes through interfaces of two media. Because the second Fresnel factor is introduced, the second highlight value is related to the light intensity ratio (the ratio between the light reflection intensity and the light transmission intensity when the light penetrates the interfaces of the two media), accuracy of the second highlight value is improved.

The original reflection value is the original reflection value of the to-be-rendered position on the exterior surface layer. Different to-be-rendered positions may have different original reflection values on the exterior surface layer. In an actual application, the original reflection value of the exterior surface layer may be a diffuse reflection value.

After the light emitted by the direct light source is transmitted through the varnish layer and illuminated on the exterior surface layer, part of the light emitted by the direct light source transmitted through the varnish layer is used as direct transmission light that affects the original reflection value of the exterior surface layer, to obtain the reflection value.

The second line-of-sight direction vector is a vector on the exterior surface layer from the to-be-rendered position to the camera model. the second half-way vector is an intermediate vector between the light source direction vector and the second line-of-sight direction vector of the exterior surface layer. The light source direction vector of the exterior surface layer is configured for representing a direction in which the direct transmission light is illuminated on the to-be-rendered position of the exterior surface layer. The light source direction vector of the exterior surface layer may also be understood as a direction vector of the direct transmission light.

The second normal vector of the exterior surface layer is a second normal vector of the to-be-rendered position on the exterior surface layer. The second normal vector of the to-be-rendered position affects the second highlight value of the to-be-rendered position. When second normal vectors of different candidate positions are different, second highlight values of the different to-be-rendered positions are also different, so that a rough effect of the exterior surface layer can be rendered.

The reflectivity corresponding to the second normal vector is a reflectivity of the to-be-rendered position in the second normal direction. The second Fresnel factor is a Fresnel factor of the to-be-rendered position on the exterior surface layer.

In some embodiments, the terminal may obtain a diffuse reflection map of the exterior surface layer, and obtains the original reflection value of the to-be-rendered position on the exterior surface layer from the diffuse reflection map; and determines a reflection value of the to-be-rendered position on the exterior surface layer under the direct transmission light based on the original reflection value of the to-be-rendered position on the exterior surface layer, the transmittance of the to-be-rendered position on the varnish layer, and the reflection intensity of the to-be-rendered position on the varnish layer.

The terminal obtains a light source direction vector and the second line-of-sight direction vector of the to-be-rendered position on the exterior surface layer, determines the second half-way vector based on the light source direction vector and the second line-of-sight direction vector of the exterior surface layer, and obtains the reflectivity corresponding to the second normal vector.

The terminal may determine a second Fresnel factor of the to-be-rendered position on the exterior surface layer based on the second line-of-sight direction vector of the to-be-rendered position on the exterior surface layer, the second half-way vector, and the reflectivity corresponding to the second normal vector.

The terminal obtains an initial Fresnel value of the to-be-rendered position on the exterior surface layer, the initial Fresnel value being configured for represent a Fresnel factor when light is vertically injected. The terminal determines a product of the initial Fresnel value of the to-be-rendered position on the exterior surface layer, the second Fresnel factor, and the reflectivity of the to-be-rendered position in the second normal direction, to obtain the second highlight value of the to-be-rendered position on the exterior surface layer.

A second highlight value of each to-be-rendered position on the exterior of the virtual object on the exterior surface layer may be determined in the foregoing manner.

In the foregoing embodiment, the reflection value of the exterior surface layer for the direct transmission light is determined in combination with the original reflection value of the original exterior surface layer and the transmittance and the reflection intensity of the varnish layer, so that accuracy of the determined reflection value of the exterior surface layer covered with the varnish layer is improved. The second Fresnel factor is introduced, so that the second highlight value is related to the ratio of the light reflection intensity to the light transmission intensity when the light passes through the interfaces of the two media, thereby improving accuracy of the second highlight value. Subsequently, an illumination result of the exterior surface layer under the direct light source is determined through the reflection value and the second highlight value, so that a rendering effect of the exterior surface layer covered with the varnish layer is more realistic.

In some embodiments, the determining, based on the original reflection value, the transmittance, and the reflection intensity of the varnish layer, a reflection value of the exterior surface layer for reflecting direct transmission light includes: determining a candidate reflection value of the exterior surface layer based on the original reflection value, the transmittance, and the initial Fresnel value; and performing interpolation on the original reflection value and the candidate reflection value based on the reflection intensity of the varnish layer, to obtain the reflection value of the exterior surface layer for reflecting the direct transmission light. The interpolation is performed based on the reflection intensity of the varnish layer, so that the reflection value is related to the reflection intensity of the varnish layer, thereby improving accuracy of the reflection value.

In some embodiments, the terminal determines a product of the reflection value of the to-be-rendered position on the exterior surface layer, the transmittance, and the initial Fresnel value, to obtain the candidate reflection value. The terminal performs interpolation on the original reflection value and the candidate reflection value based on a reflection intensity of the to-be-rendered position on the exterior surface layer, to obtain the reflection value of the exterior surface layer for reflecting the direct transmission light. In other words, the reflection value is determined based on the transmittance of the varnish layer and the reflection intensity of the exterior surface layer, so that the reflection value can better manifest the reflection effect of the exterior surface layer for the light that is emitted by the direct light source and that penetrates the varnish layer.

In some embodiments, before the obtaining an original reflection value of the exterior surface layer and a transmittance of the varnish layer, the method further includes: obtaining a color pixel value, a metalness, and a thickness of the varnish layer, determining, based on the thickness, the first normal vector of the varnish layer, the first line-of-sight direction vector, and the light source direction vector of the direct light source, a path distance for light emitted by the direct light source to penetrate the varnish layer, determining an extinction factor based on the color pixel value, and determining a light depth based on the extinction factor, the thickness, and the path distance; and determining the transmittance of the varnish layer based on the light depth and the extinction factor.

The terminal obtains a color map of the varnish layer, and obtains the color pixel value of the to-be-rendered position on the varnish layer from the color map. The terminal obtains a metalness map of the varnish layer, and obtains the metalness of the to-be-rendered position on the varnish layer from the metalness map. The thickness is a thickness of the varnish layer, and may be set based on an exterior display effect of the virtual object.

The metalness of the to-be-rendered position on the varnish layer is used as an initial extinction factor of the to-be-rendered position on the varnish layer. When the initial extinction factor satisfies a normalization condition, the thickness of the to-be-rendered position on the varnish layer is normalized to obtain a normalized thickness. The normalized thickness is further normalized based on the first normal vector, the first line-of-sight direction vector, and the light source direction vector, to obtain the path distance for the light emitted by the direct light source to penetrate the varnish layer. The terminal processes the color pixel value based on a function corresponding to the Beer-Lambert law, to obtain a transmission pixel value of the to-be-rendered position on the exterior surface layer, determines the extinction factor based on the transmission pixel value and the normalized thickness, and determines the light depth based on the extinction factor, the path distance, and the normalized thickness. The terminal obtains an initial transmittance of the to-be-rendered position on the varnish layer, and performs interpolation on the initial transmittance and a candidate transmittance based on the initial extinction factor, to obtain the transmittance of the varnish layer.

Further normalizing the normalized thickness based on the first normal vector, the first line-of-sight direction vector, and the light source direction vector, to obtain the path distance for the light emitted by the direct light source to penetrate the varnish layer includes: fusing the first normal vector and the first line-of-sight direction vector, to obtain a second fusion result, and fusing the first normal vector and the light source direction vector of the varnish layer, to obtain a third fusion result; and determining, based on the second fusion result, the third fusion result, and the normalized thickness, the path distance for the light emitted by the direct light source to penetrate the varnish layer.

The Beer-Lambert law describes an attenuation law of light during propagation in a medium. To be specific, intensity of the light exponentially decreases as a propagation distance increases.

In the foregoing embodiment, the path distance for the light emitted by the direct light source to penetrate the varnish layer is determined based on the color pixel value, the metalness, and the thickness of the varnish layer; the light depth is determined based on the extinction factor, the thickness of the varnish layer, and the path distance, and the transmittance of the varnish layer is determined based on the light depth and the extinction factor. The transmittance of the varnish layer is configured for describing a degree of attenuation after the light penetrates the varnish layer. Therefore, the light that is emitted by the direct light source and that penetrates the varnish layer may be determined based on the transmittance, thereby improving the reflection value of the exterior surface layer for reflecting the direct transmission light and the accuracy of the highlight value generated on the exterior surface layer by direct projection light.

In some embodiments, the terminal may also process the second fusion result, the third fusion result, the color pixel value, and the metalness of the to-be-rendered position on the varnish layer through a CalcThinTransmission function in the PBR illumination model, to obtain the transmittance of the to-be-rendered position on the varnish layer. The CalcThinTransmission function is a function configured for calculating inter-layer transmission. Directly determining the transmittance of the varnish layer through the CalcThinTransmission function can reduce a duration required for determining the transmittance, and improve the rendering efficiency.

In the foregoing embodiment, the candidate reflection value is determined through the initial Fresnel value, the original reflection value, and the transmittance of the varnish layer, the interpolation is performed on the original reflection value and the candidate reflection values based on the reflection intensity of the varnish layer, to obtain the reflection value, so that the reflection value is affected by the reflection intensity of the varnish layer, thereby improving the accuracy of the reflection values. The exterior surface layer covered with the varnish layer is rendered based on the reflection value, so that the exterior surface layer covered with the varnish layer can have a more realistic reflection effect under the direct light source.

In some embodiments, the determining a second Fresnel factor of the exterior surface layer based on a second line-of-sight direction vector of the exterior surface layer, a second half-way vector, and a reflectivity corresponding to a second normal vector includes: fusing the second line-of-sight direction vector and the second half-way vector of the exterior surface layer, to obtain a fourth fusion result; and determining the second Fresnel factor of the exterior surface layer based on the fourth fusion result and the reflectivity corresponding to the second normal vector. The accuracy of the second highlight value is improved, thereby improving a highlight effect of the exterior surface layer covered with the varnish layer under the direct light source.

In some embodiments, the fusing, by the terminal, the second line-of-sight direction vector and the second half-way vector of the exterior surface layer may be performing dot multiplication on the second line-of-sight direction vector and the second half-way vector. For example, the fourth fusion result is Bottom VdH. Bottom VdH=dot (V2, H2), V2 being the second line-of-sight direction vector, and H2 being the second half-way vector. The terminal may determine the second Fresnel factor through a simplified Fresnel equation based on the fourth fusion vector and the reflectivity corresponding to the second normal vector, as shown in an equation (1).

$$BottomF = {f}_{0} + ( 1 - {f}_{0} ) {( 1 - BottomVdH )}^{5} . \qquad Equation ( 1 )$$

BottomF is the second Fresnel factor of the to-be-rendered position on the exterior surface layer. f₀ is the reflectivity corresponding to the second normal vector of the to-be-rendered position on the exterior surface layer. BottomVdH is the fourth fusion result of the to-be-rendered position on the exterior surface layer.

In the foregoing embodiment, the second Fresnel factor is determined based on the fourth fusion result and the reflectivity corresponding to the second normal vector, so as to subsequently determine the second highlight value based on the second Fresnel factor, so that the second highlight value is related to the ratio of the light reflection intensity to the light transmission intensity when the light passes through the varnish layer and the exterior surface layer, thereby improving the accuracy of the second highlight value, and improving the highlight effect of the exterior surface layer covered with the varnish layer under the direct light source.

In some embodiments, the exterior rendering method for a virtual object includes: determining a third highlight value of the varnish layer under an indirect light source based on the varnish layer roughness and an ambient light map of an environment in which the virtual object is located; and determining, based on an exterior surface layer roughness of the virtual object and the ambient light map, a fourth highlight value generated on the exterior surface layer by indirect transmission light, the indirect transmission light being light that is emitted by the indirect light source and that is transmitted through the varnish layer. The determining a target illumination value based on the first highlight value, the reflection value, and the second highlight value includes: determining the target illumination value based on the first highlight value, the reflection value, the second highlight value, the third highlight value, and the fourth highlight value. The highlight effects and the reflection effects generated under the direct light source and the indirect light source on the varnish layer and the exterior surface layer are superposed, so that the varnish texture of the exterior surface layer is more realistic, thereby improving the visual effect.

The light source of the virtual environment further includes an indirect light source, and light emitted by the indirect light source is from an object in the virtual scene. For example, the light emitted by the indirect light source may be light reflected by an object when the light emitted by the direct light source is illuminated on the object. In an actual application, the light emitted by the indirect light source may be simulated through the ambient light map.

The first highlight value, the reflection value, and the second highlight value are determined based on the light emitted by the direct light source, and the third highlight value and the fourth highlight value are determined based on the light emitted by the indirect light source.

The exterior surface layer roughness is a roughness of the to-be-rendered position on the exterior surface layer, and exterior surface layer roughness of different to-be-rendered positions are different.

The varnish layer performs specular reflection on the light emitted by the indirect light source. The third highlight value may be configured for indicating a degree of the specular reflection of the varnish layer for the light emitted by the indirect light source. The light emitted by the indirect light source is transmitted through the varnish layer and then illuminated on the exterior surface layer, and the light that is emitted by the indirect light source and that is transmitted through the varnish layer is used as the indirect transmission light. The exterior surface layer performs specular reflection on the indirect transmission light. The fourth highlight value may be configured for indicating a degree of the specular reflection of the exterior surface layer for the indirect transmission light.

In some embodiments, the terminal determines a first color pixel value of the to-be-rendered position on the varnish layer based on the varnish layer roughness of the to-be-rendered position and the ambient light map, and determines a third highlight value of the to-be-rendered position on the varnish layer under the indirect light source based on the first color pixel value of the to-be-rendered position on the varnish layer and the first Fresnel factor. The terminal determines a second color pixel value of the to-be-rendered position on the exterior surface layer based on the exterior surface layer roughness of the to-be-rendered position and the ambient light map, and determines a fourth highlight value of the to-be-rendered position on the exterior surface layer under the indirect light source based on the second color pixel value of the to-be-rendered position on the exterior surface layer and the second Fresnel factor. A highlight effect of the varnish layer under the indirect light source may be obtained through rendering by using the third highlight value, and a highlight effect of the exterior surface layer under the indirect light source may be obtained through rendering by using the fourth highlight value. A more real highlight effect may be obtained through a combination of the highlight effects of the varnish layer and the exterior surface layer under the direct light source and the indirect light source.

In some embodiments, the terminal performs linear processing based on the first highlight value and the third highlight value of the varnish layer, to obtain the illumination value of the varnish layer, the terminal performs linear processing based on the reflection value, the second highlight value, and the fourth highlight value of the exterior surface layer, to obtain the illumination value of the exterior surface layer, and the terminal determines the target illumination value based on the illumination value of the varnish layer and the illumination value of the exterior surface layer. The first highlight value, the reflection value, the second highlight value, the third highlight value, and the fourth highlight value correspond to the same to-be-rendered position on the exterior of the virtual object. The target illumination value is determined based on the illumination value of the varnish layer and the illumination value of the exterior surface layer, and rendering is performed based on the target illumination value, so that a display effect of the varnish layer and a display effect of the exterior surface layer can be superposed, to obtain the visual effect of the exterior surface layer covered with the varnish layer. Therefore, the exterior surface layer has a varnish texture.

In some embodiments, the terminal determines the illumination value under the direct light source based on the first highlight value of the varnish layer, the reflection value of the exterior surface layer, and the second highlight value, determines the illumination value under the indirect light source based on the third highlight value of the varnish layer and the fourth highlight value of the exterior surface layer, and determines the target illumination value based on the illumination value under the direct light source and the illumination value under the indirect light source. Similarly, the first highlight value, the reflection value, the second highlight value, the third highlight value, and the fourth highlight value correspond to the same to-be-rendered position on the exterior of the virtual object. The target illumination value is determined based on the illumination value under the direct light source and the illumination value under the indirect light source, and the rendering is performed based on the target illumination value, so that the display effect of the exterior surface layer covered with the varnish layer under the direct light source and the display effect of the exterior surface layer covered with the varnish layer under the indirect light source can be superposed. Therefore, the rendered exterior surface layer covered with the varnish layer has richer illumination forms, thereby improving the visual effect.

In the foregoing embodiment, the indirect light source is introduced through the ambient light map, the third highlight value obtained through the specular reflection performed by the varnish layer on the light emitted by the indirect light source and the fourth highlight value obtained through the specular reflection performed by the exterior surface layer on the indirect transmission light are determined, and the target illumination value is determined through the first highlight value, the reflection value, the second highlight value, the third highlight value, and the fourth highlight value, so that the highlight effects and the reflection effects generated under the direct light source and the indirect light source by the varnish layer and the exterior surface layer can be superposed. The exterior rendering is performed on the exterior of the virtual object through the target illumination value, so that the visual effect of the exterior surface layer covered with the varnish layer can be obtained. In addition, the exterior surface layer has a more real varnish texture, thereby improving the visual effect.

In some embodiments, the determining a third highlight value of the varnish layer under an indirect light source based on the varnish layer roughness and an ambient light map of an environment in which the virtual object is located includes: determining a first color pixel value of the varnish layer in the ambient light map of the environment in which the virtual object is located based on the varnish layer roughness and the first normal vector and the first line-of-sight direction vector of the varnish layer; and determining the third highlight value of the varnish layer under the indirect light source based on the first color pixel value, an indirect light source reflectivity of the varnish layer, a light intensity of the indirect light source, and the first Fresnel factor of the varnish layer. The highlight effect of the varnish layer under the indirect light source may be obtained through rendering by using the third highlight value.

The ambient light map is configured for representing an ambient illumination situation of the exterior of the virtual object. In an actual application, the ambient light map may be a cubic ambient light illumination map formed by six two-dimensional texture images of the virtual environment.

The indirect light source reflectivity of the varnish layer is configured for representing a reflectivity contribution of the indirect light source to the varnish layer. In an actual application, the indirect light source reflectivity of the varnish layer may be determined through pre-calculated diffuse reflection and specular reflection values of a bidirectional reflection distribution of the environment.

In some embodiments, the terminal obtains the pre-calculated diffuse reflection value and the pre-calculated specular reflection value of the bidirectional reflection distribution of the environment, obtains the reflectivity corresponding to the first normal vector of the varnish layer, and determines the indirect light source reflectivity of the varnish layer based on the reflectivity corresponding to the first normal vector, the pre-calculated diffuse reflection value and the pre-calculated specular reflection value of the bidirectional reflection distribution of the environment. For example, the indirect light source reflectivity is: f0*dfg.x+dfg.y, f0 being the reflectivity corresponding to the first normal vector of the varnish layer, dfg.x being a weighted sum of pre-calculated diffuse reflection values of the bidirectional reflection distribution of the environment, and dfg.y being a weighted sum of pre-calculated specular reflection values of the bidirectional reflection distribution of the environment.

The terminal obtains the first normal vector and the first line-of-sight direction vector of the to-be-rendered position on the varnish layer, and determines a first reflection direction vector of the to-be-rendered position on the varnish layer. In an actual application, the first normal vector and the first line-of-sight direction vector of the to-be-rendered position on the varnish layer may be processed through a reflection function of the PBR model, to obtain the first reflection direction vector of the to-be-rendered position on the varnish layer.

The terminal samples the first color pixel value of the to-be-rendered position on the varnish layer from the ambient light map based on the varnish layer roughness and the first reflection direction vector. The terminal obtains the light intensity of the indirect light source and a first Fresnel factor of the to-be-rendered position on the varnish layer; and determines a product of the first color pixel value, the indirect light source reflectivity of the varnish layer, the light intensity of the indirect light source, and the first Fresnel factor of the varnish layer, to obtain the third highlight value of the to-be-rendered position on the varnish layer. A third highlight value of each to-be-rendered position on the exterior of the virtual object on the varnish layer may be obtained in the foregoing manner. The indirect light source is introduced through the ambient light map, so that the reflection effect of the varnish layer for the indirect light source by the varnish layer is improved, and the first Fresnel factor is introduced, so that a varnish effect of a central region of the exterior surface layer covered with the varnish layer can be improved.

In some embodiments, the exterior rendering method for a virtual object further includes: determining an edge adjustment factor based on the first Fresnel factor. The determining the third highlight value of the varnish layer under the indirect light source based on the first color pixel value, an indirect light source reflectivity of the varnish layer, a light intensity of the indirect light source, and the first Fresnel factor of the varnish layer includes: determining the third highlight value of the varnish layer under the indirect light source based on the first color pixel value, the indirect light source reflectivity of the varnish layer, the light intensity of the indirect light source, the first Fresnel factor of the varnish layer, and the edge adjustment factor.

Specifically, the edge adjustment factor may be a difference between 1 and the first Fresnel factor. The terminal determines a product of the first color pixel value, the indirect light source reflectivity of the varnish layer, the light intensity of the indirect light source, the first Fresnel factor of the varnish layer, and the edge adjustment factor, to obtain the third highlight value.

When an edge region of the exterior surface layer covered with the varnish layer has a relatively strong varnish effect, for example, the edge region has a relatively strong highlight effect, and a highlight effect of a central region needs to be weakened, the edge adjustment factor may be introduced. To be specific, the third highlight value is determined based on the first color pixel value, the indirect light source reflectivity of the varnish layer, the light intensity of the indirect light source, the first Fresnel factor of the varnish layer, and the edge adjustment factor, and the target illumination value is determined based on the third highlight value for rendering, so that the varnish effect of the edge region can be weakened.

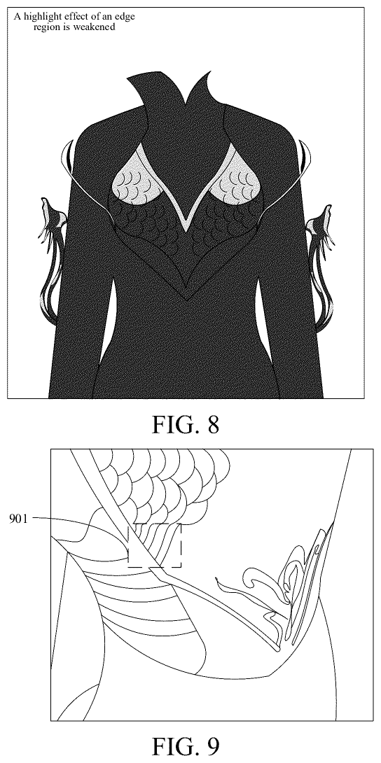

For example, FIG. 7 shows a rendered armor (including a breastplate and a pauldron) of the virtual object when the edge adjustment factor is not introduced, and FIG. 8 shows a rendered armor of the virtual object when the edge adjustment factor is introduced. It may be learned by comparison that after the edge adjustment factor is introduced, highlight effects of edge regions of the rendered breastplate and pauldron are weakened.

In some embodiments, a specular reflection effect of the varnish layer for ambient light (emitted by an indirect light source) may be improved through increase of an intensity of the ambient light and reduction of the varnish layer roughness.

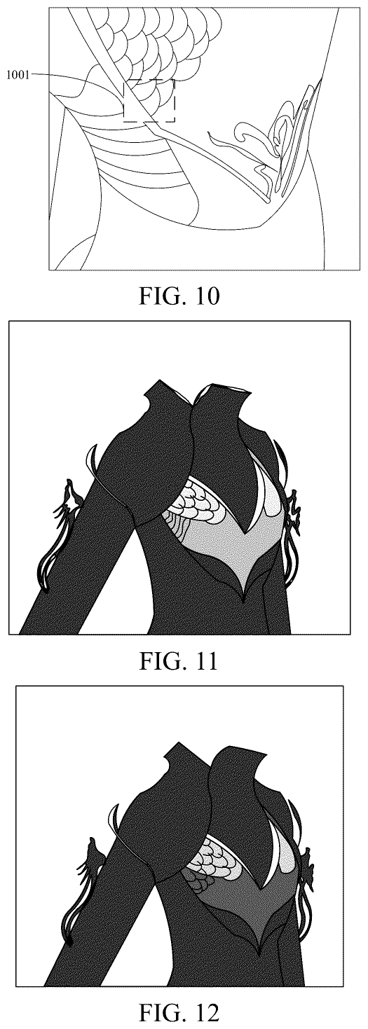

When the varnish layer has a strong specular reflection effect on ambient light, abnormal stretching may occur on the rendered exterior surface layer covered with the varnish layer, as shown in 901 in FIG. 9. The ambient light map may be adjusted, to reduce a brightness of a ground map in the virtual scene, so as to reduce the specular reflection effect of the varnish layer on the ambient light, thereby alleviating the abnormal stretching of the rendered exterior surface layer covered with the varnish layer. The rendered exterior surface layer covered with the varnish layer after the brightness of the ground map in the virtual scene is reduced is shown in FIG. 10. It may be learned by comparison that after the brightness of the ground map in the virtual scene is reduced, the abnormal stretching of the rendered exterior surface layer covered with the varnish layer is alleviated, as shown in 1001 in FIG. 10.

On the whole, a rendering effect of the exterior when the ambient light map is not adjusted is shown in FIG. 11, and a rendering effect of the exterior when the ambient light map is adjusted is shown in FIG. 12. It may be learned by comparison that a brightness of the exterior shown in FIG. 11 is higher than a brightness of the exterior shown in FIG. 12, and the armor of FIG. 11 has abnormal stretching, while the armor of FIG. 12 does not have abnormal stretching. After the brightness of the ground map in the virtual scene is reduced, the abnormal stretching situation of the rendered exterior surface layer covered with the varnish layer is alleviated.

In the foregoing embodiment, the first color pixel value is sampled from the ambient light map, the third highlight value of the varnish layer under the indirect light source is determined based on the first color pixel value, the indirect light source reflectivity of the varnish layer, the light intensity of the indirect light source, and the first Fresnel factor of the varnish layer. The first Fresnel factor is introduced, so that the incident angle of the light emitted by the indirect light source affects the reflection effect of the varnish layer, thereby improving the accuracy of the third highlight value, and improving the highlight effect of the varnish layer under the indirect light source.

In some embodiments, the determining, based on an exterior surface layer roughness of the virtual object and the ambient light map, a fourth highlight value generated on the exterior surface layer by indirect transmission light includes: obtaining a second color pixel value of the exterior surface layer in the ambient light map based on the exterior surface layer roughness of the virtual object and the second line-of-sight direction vector and the second normal vector of the exterior surface layer; and determining, based on the second color pixel value, the indirect light source reflectivity of the exterior surface layer, the light intensity of the indirect light source, and the second Fresnel factor of the exterior surface layer, the fourth highlight value generated on the exterior surface layer by the indirect transmission light. The highlight effect of the exterior surface layer under the indirect light source may be obtained through rendering by using the fourth highlight value.

The indirect light source reflectivity of the exterior surface layer is configured for representing a reflectivity contribution of the indirect light source to the exterior surface layer. In an actual application, the indirect light source reflectivity of the exterior surface layer may be determined through pre-calculated diffuse reflection and specular reflection values of the bidirectional reflection distribution of the environment.

In some embodiments, the terminal obtains the pre-calculated diffuse reflection value and the pre-calculated specular reflection value of the bidirectional reflection distribution of the environment, obtains the reflectivity corresponding to the second normal vector of the exterior surface layer, and determines the indirect light source reflectivity of the exterior surface layer based on the reflectivity corresponding to the second normal vector and the pre-calculated diffuse reflection value and the pre-calculated specular reflection value of the bidirectional reflection distribution of the environment.

The terminal obtains the second normal vector and the second line-of-sight direction vector of the to-be-rendered position on the exterior surface layer, and determines a second reflection direction vector of the to-be-rendered position on the exterior surface layer. In an actual application, the second normal vector and the second line-of-sight direction vector of the to-be-rendered position on the exterior surface layer may be processed through a reflection function of the PBR model, to obtain the second reflection direction vector of the to-be-rendered position on the exterior surface layer.

The terminal samples the second color pixel value of the to-be-rendered position on the exterior surface layer from the ambient light map based on the exterior surface layer roughness and the second reflection direction vector. The terminal obtains the light intensity of the indirect light source and the second Fresnel factor of the to-be-rendered position on the exterior surface layer. The terminal determines a Fresnel transmission factor based on the second Fresnel factor, and determines a product of the second color pixel value, the indirect light source reflectivity of the exterior surface layer, the light intensity of the indirect light source, and the Fresnel transmission factor, to obtain the fourth highlight value of the to-be-rendered position on the exterior surface layer. A fourth highlight value of each to-be-rendered position on the exterior of the virtual object on the exterior surface layer may be obtained in the foregoing manner.

Determining, by the terminal, the Fresnel transmission factor based on the second Fresnel factor may be determining a difference between 1 and the second Fresnel factor, to obtain the Fresnel transmission factor.

In the foregoing embodiment, the second color pixel value is sampled from the ambient light map, and the fourth highlight value generated on the exterior surface layer by the indirect transmission light is determined based on the second color pixel value, the indirect light source reflectivity of the exterior surface layer, the light intensity of the indirect light source, and the second Fresnel factor of the exterior surface layer, so that the highlight effect of the exterior surface layer under the indirect light source is improved.

In some embodiments, the determining the target illumination value based on the first highlight value, the reflection value, the second highlight value, the third highlight value, and the fourth highlight value includes: determining an illumination value of a to-be-rendered position on the varnish layer based on the first highlight value and the third highlight value; determining an illumination value of the to-be-rendered position on the exterior surface layer based on the reflection value, the second highlight value, and the fourth highlight value; and determining the target illumination value of the to-be-rendered position based on an illumination value of the to-be-rendered position on the varnish layer and the illumination value of the to-be-rendered position on the exterior surface layer. The highlight effects and the reflection effects generated under the direct light source and the indirect light source on the varnish layer and the exterior surface layer are superposed, and exterior rendering is performed on the exterior of the virtual object through the target illumination value, so that the varnish texture of the exterior surface layer is more realistic, thereby improving the visual effect.

In some embodiments, the terminal performs linear processing on the first highlight value and the third highlight value of the to-be-rendered position, to obtain the illumination value of the to-be-rendered position on the varnish layer. The terminal performs linear processing on the reflection value, the second highlight value, and the fourth highlight value of the to-be-rendered position, to obtain the illumination value of the to-be-rendered position on the exterior surface layer. The terminal performs linear processing on the illumination value of the to-be-rendered position on the varnish layer and the illumination value on the exterior surface layer, to obtain the target illumination value of the to-be-rendered position. The target illumination value is determined in combination with the illumination values of the varnish layer and the exterior surface layer under the direct light source and the indirect light source, so that the target illumination value can manifest a comprehensive illumination value of the varnish layer and the exterior surface layer under the direct light source and the indirect light source. Therefore, rendering may be performed based on the target illumination value, to combine the illumination effects of the varnish layer and the exterior surface layer, thereby improving the visual effect of the exterior.

In some embodiments, performing, by the terminal, the linear processing on the first highlight value and the third highlight value of the to-be-rendered position, to obtain the illumination value of the to-be-rendered position on the varnish layer may be adding the first highlight value and the third highlight value together, to obtain the illumination value of the to-be-rendered position on the varnish layer. Adding the first highlight value and the third highlight value together can reduce hardware resources required for determining the illumination value on the varnish layer, and improve rendering efficiency.

Performing, by the terminal, the linear processing on the first highlight value and the third highlight value of the to-be-rendered position, to obtain the illumination value of the to-be-rendered position on the varnish layer may alternatively be obtaining, by the terminal, weights of the direct light source and the indirect light source, and performing weighted summation on the first highlight value and the third highlight value based on the weights of the direct light source and the indirect light source, to obtain the illumination value of the to-be-rendered position on the varnish layer. The weighted summation is performed on the first highlight value and the third highlight value, so that the illumination value on the varnish layer can bias to one of the first highlight value and the third highlight value with a higher weight, thereby highlighting the illumination effect of the varnish layer under the direct light source or the indirect light source.

In some embodiments, performing, by the terminal, the linear processing on the reflection value, the second highlight value, and the fourth highlight value of the to-be-rendered position, to obtain an illumination value of the to-be-rendered position on the exterior surface layer may be adding the reflection value, the second highlight value, and the fourth highlight value of the to-be-rendered position together, to obtain the illumination value of the to-be-rendered position on the exterior surface layer, or may be adding, by the terminal, the reflection value and the second value together, to obtain a first addition result, and performing weighted summation on the first addition result and the fourth highlight value based on the weights of the direct light source and the indirect light source, to obtain the illumination value of the to-be-rendered position on the exterior surface layer. Adding the reflection value, the second highlight value, and the fourth highlight value are added together can reduce hardware resources required for determining the illumination value of the exterior surface layer, and improve rendering efficiency. The weighted summation is performed on the first addition result and the fourth highlight value, so that the illumination value of the exterior surface layer can bias to one of the first addition result and the fourth highlight value with a higher weight, thereby highlighting the illumination effect of the exterior surface layer under the direct light source or the indirect light source.

Performing, by the terminal, the linear processing on the reflection value, the second highlight value, and the fourth highlight value of the to-be-rendered position, to obtain the illumination value of the to-be-rendered position on the exterior surface layer may alternatively be adding, by the terminal, the second highlight value and the fourth highlight value together, to obtain a second addition result, obtaining a reflection weight and a highlight weight, and performing weighted summation on the reflection value and the second addition result based on the reflection weight and the highlight weight, to obtain the illumination value of the to-be-rendered position on the exterior surface layer. The weighted summation is performed on the reflection value and the second addition result, so that the illumination value on the exterior surface layer can bias to one of the reflection value and the second addition result with a higher weight, thereby highlighting the reflection effect or the highlight effect of the exterior surface layer.

In some embodiments, performing, by the terminal, the linear processing on the illumination value of the to-be-rendered position on the varnish layer and the illumination value on the exterior surface layer, to obtain the target illumination value of the to-be-rendered position may be adding the illumination value of the to-be-rendered position on the varnish layer and the illumination value on the exterior surface layer together, to obtain the target illumination value of the to-be-rendered position, or may be performing weighted summation on the illumination value of the to-be-rendered position on the varnish layer and the illumination value on the exterior surface layer based on weights of the varnish layer and the exterior surface layer, to obtain the target illumination value of the to-be-rendered position.

In the foregoing embodiment, the target illumination value is determined through the first highlight value, the reflection value, the second highlight value, the third highlight value, and the fourth highlight value, so that the highlight effects and the reflection effects generated under the direct light source and the indirect light source by the varnish layer and the exterior surface layer can be superposed. The exterior rendering is performed on the exterior of the virtual object through the target illumination value, so that the visual effect of the exterior surface layer covered with the varnish layer can be obtained. In addition, the exterior surface layer has a more real varnish texture, thereby improving the visual effect.

In some embodiments, the exterior rendering for the virtual object may be applied to a scenario in which an exterior of a virtual object in a virtual scene is to be rendered. For example, a material of an exterior surface layer of the virtual object is a silk material. A varnish layer is covered on the silk, to simulate a texture of the silk material in a real environment, thereby improving a display effect of the silk material.

The terminal determines a reflection roughness of the varnish layer based on a varnish layer roughness of the virtual object, a first normal vector of the varnish layer, and a first half-way vector, determines a visibility of the varnish layer based on the varnish layer roughness, the first normal vector, a first line-of-sight direction vector, and a light source direction vector of the direct light source, and determines a first highlight value of the varnish layer under a direct light source based on the reflection roughness, the visibility, and a reflection intensity of the varnish layer.

The terminal determines, based on an original reflection value of the exterior surface layer of the silk material, and a transmittance and the reflection intensity of the varnish layer, a reflection value of the exterior surface layer of the silk material for reflecting direct transmission light; determines a second Fresnel factor of the exterior surface layer of the silk material based on the second line-of-sight direction vector of the exterior surface layer of the silk material, the second half-way vector, and a reflectivity corresponding to the second normal vector; and determines, based on the transmittance and the second Fresnel factor, a second highlight value generated on the exterior surface layer of the silk material by the direct transmission light.

The terminal determines a third highlight value of the varnish layer under an indirect light source based on the varnish layer roughness and an ambient light map of an environment in which the virtual object is located; and determines, based on a roughness of the exterior surface layer of the silk material and the ambient light map, a fourth highlight value generated on the exterior surface layer of the silk material by indirect transmission light.

The terminal determines a target illumination value based on the first highlight value, the reflection value, the second highlight value, the third highlight value, and the fourth highlight value.

The exterior surface layer of the silk material is covered with the varnish layer without adding a material of another type, so that an effect of the exterior surface layer of the silk material covered with the varnish layer can be obtained through rendering with relatively small occupation of hardware resources, and the exterior of the silk material has a varnish texture.

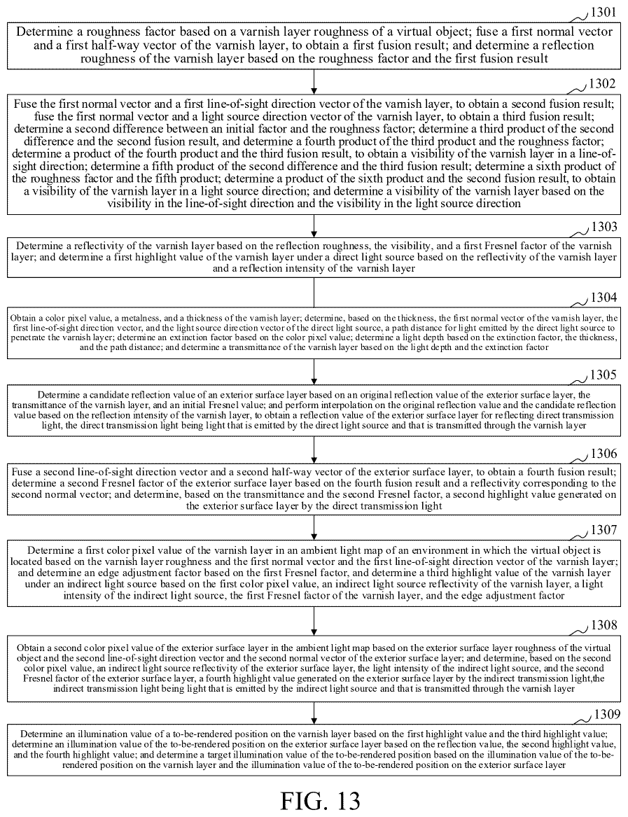

In some embodiments, as shown in FIG. 13, an exterior rendering method for a virtual object includes the following operations:

Operation 1301: Determine a roughness factor based on a varnish layer roughness of a virtual object; fuse a first normal vector and a first half-way vector of the varnish layer, to obtain a first fusion result; and determine a reflection roughness of the varnish layer based on the roughness factor and the first fusion result.

Operation 1302: Fuse the first normal vector and a first line-of-sight direction vector of the varnish layer, to obtain a second fusion result; fuse the first normal vector and a light source direction vector of the varnish layer, to obtain a third fusion result; determine a second difference between an initial factor and the roughness factor; determine a third product of the second difference and the second fusion result, and determine a fourth product of the third product and the roughness factor; determine a product of the fourth product and the third fusion result, to obtain a visibility of the varnish layer in a line-of-sight direction; determine a fifth product of the second difference and the third fusion result; determine a sixth product of the roughness factor and the fifth product; determine a product of the sixth product and the second fusion result, to obtain a visibility of the varnish layer in a light source direction; and determine a visibility of the varnish layer based on the visibility in the line-of-sight direction and the visibility in the light source direction.

Operation 1303: Determine a reflectivity of the varnish layer based on the reflection roughness, the visibility, and a first Fresnel factor of the varnish layer; and determine a first highlight value of the varnish layer under a direct light source based on the reflectivity of the varnish layer and a reflection intensity of the varnish layer.

Operation 1304: Obtain a color pixel value, a metalness, and a thickness of the varnish layer; determine, based on the thickness, the first normal vector of the varnish layer, the first line-of-sight direction vector, and the light source direction vector of the direct light source, a path distance for light emitted by the direct light source to penetrate the varnish layer; determine an extinction factor based on the color pixel value; determine a light depth based on the extinction factor, the thickness, and the path distance; and determine a transmittance of the varnish layer based on the light depth and the extinction factor.

Operation 1305: Determine a candidate reflection value of an exterior surface layer based on an original reflection value of the exterior surface layer, the transmittance of the varnish layer, and an initial Fresnel value; and perform interpolation on the original reflection value and the candidate reflection value based on the reflection intensity of the varnish layer, to obtain a reflection value of the exterior surface layer for reflecting direct transmission light, the direct transmission light being light that is emitted by the direct light source and that is transmitted through the varnish layer.

Operation 1306: Fuse a second line-of-sight direction vector and a second half-way vector of the exterior surface layer, to obtain a fourth fusion result; determine a second Fresnel factor of the exterior surface layer based on the fourth fusion result and a reflectivity corresponding to the second normal vector; and determine, based on the transmittance and the second Fresnel factor, a second highlight value generated on the exterior surface layer by the direct transmission light.

Operation 1307: Determine a first color pixel value of the varnish layer in an ambient light map of an environment in which the virtual object is located based on the varnish layer roughness and the first normal vector and the first line-of-sight direction vector of the varnish layer; and determine an edge adjustment factor based on the first Fresnel factor, and determine a third highlight value of the varnish layer under an indirect light source based on the first color pixel value, an indirect light source reflectivity of the varnish layer, a light intensity of the indirect light source, the first Fresnel factor of the varnish layer, and the edge adjustment factor.

Operation 1308: Obtain a second color pixel value of the exterior surface layer in the ambient light map based on the exterior surface layer roughness of the virtual object and the second line-of-sight direction vector and the second normal vector of the exterior surface layer; and determine, based on the second color pixel value, an indirect light source reflectivity of the exterior surface layer, the light intensity of the indirect light source, and the second Fresnel factor of the exterior surface layer, a fourth highlight value generated on the exterior surface layer by the indirect transmission light, the indirect transmission light being light that is emitted by the indirect light source and that is transmitted through the varnish layer.

Operation 1309: Determine an illumination value of a to-be-rendered position on the varnish layer based on the first highlight value and the third highlight value; determine an illumination value of the to-be-rendered position on the exterior surface layer based on the reflection value, the second highlight value, and the fourth highlight value; and determine a target illumination value of the to-be-rendered position based on the illumination value of the to-be-renderedposition on the varnish layer and the illumination value of the to-be-rendered position on the exterior surface layer.

Although the operations in the flowcharts involved in the foregoing embodiments are displayed in a sequence based on indication of arrows, the operations are not necessarily performed sequentially based on the sequence indicated by the arrows. Unless otherwise explicitly specified in this disclosure, execution of the operations is not strictly limited, and the operations may be performed in other sequences. Moreover, at least some of the operations involved in the foregoing embodiments may include a plurality of operations or a plurality of stages. The operations or stages are not necessarily performed at the same moment but may be performed at different moments, and the operations or the stages are not necessarily sequentially performed, but may be performed alternately with other operations or at least some operations or stages of other operations.

In the foregoing exterior rendering method for a virtual object, for the varnish layer covering the exterior surface layer, the first highlight value of the varnish layer under the light source is determined, the reflection value and the second highlight value of the exterior surface layer under the light source are determined based on the original reflection value and the transmittance, the target illumination value is determined based on the first highlight value, the reflection value, and the second highlight value, and the illumination rendering is performed on the exterior of the virtual object based on the target illumination value, which can implement superposition of the highlight effect on the varnish layer and the reflection effect and the highlight effect on the exterior surface layer, to obtain the visual effect of the exterior surface layer covered with the varnish layer, so that the exterior surface layer has a varnish texture, thereby improving the visual effect.

Based on the same concept, an embodiment of this disclosure further provides an exterior rendering apparatus for a virtual object configured to implement the foregoing exterior rendering method for a virtual object. An implementation provided by the apparatus to resolve the problem is similar to the implementation recorded in the foregoing method. Therefore, for specific limitations in one or more embodiments of the exterior rendering apparatus for a virtual object provided below, reference may be made to the foregoing limitations on the exterior rendering method for a virtual object.

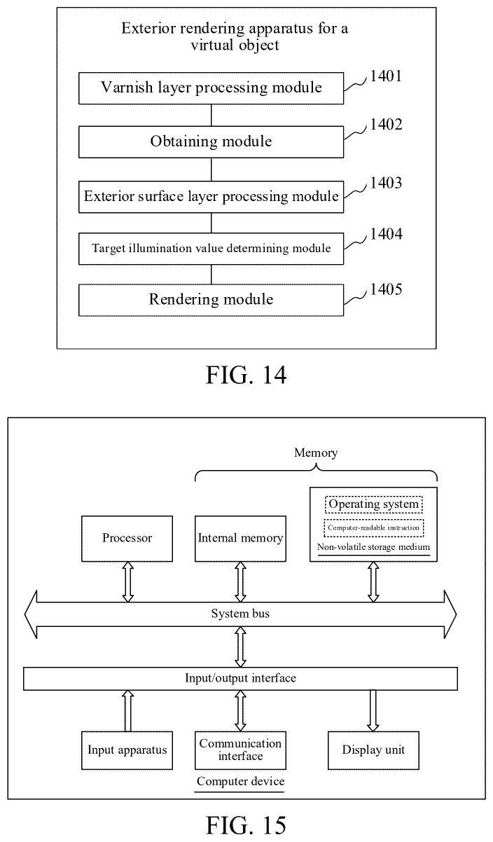

In an embodiment, as shown in FIG. 14, an exterior rendering apparatus for a virtual object is provided, including a varnish layer processing module 1401, an obtaining module 1402, an exterior surface layer processing module 1403, a target illumination value determining module 1404, and a rendering module 1405.

The varnish layer processing module 1401 is configured to determine a first highlight value of a varnish layer of a virtual object under a light source, the varnish layer being a varnish material covering an exterior surface layer of the virtual object.

The obtaining module 1402 is configured to obtain an original reflection value of the exterior surface layer and a transmittance of the varnish layer.

The exterior surface layer processing module 1403 is configured to determine a reflection value and a second highlight value of the exterior surface layer under the light source based on the original reflection value and the transmittance.

The target illumination value determining module 1404 is configured to determine a target illumination value based on the first highlight value, the reflection value, and the second highlight value.

The rendering module 1405 is configured to perform illumination rendering on an exterior of the virtual object based on the target illumination value.

In some embodiments, the light source is a direct light source, and the varnish layer processing module 1401 includes:
a reflection roughness determining unit, configured to determine a reflection roughness of the varnish layer based on a varnish layer roughness of the virtual object and a first normal vector and a first half-way vector of the varnish layer;
a visibility determining unit, configured to determine a visibility of the varnish layer based on the varnish layer roughness, the first normal vector, a first line-of-sight direction vector of the varnish layer, and a light source direction vector of the direct light source; and
a first highlight value determining unit, configured to determine the first highlight value of the varnish layer under the direct light source based on the reflection roughness, the visibility, and the reflection intensity of the varnish layer.

In some embodiments, the reflection roughness determining unit is further configured to: determine a roughness factor based on the varnish layer roughness of the virtual object; fuse the first normal vector and the first half-way vector of the varnish layer, to obtain a first fusion result; and determine the reflection roughness of the varnish layer based on the roughness factor and the first fusion result.

In some embodiments, the visibility determining unit is further configured to: determine a roughness factor based on the varnish layer roughness of the virtual object; fuse the first normal vector and the first line-of-sight direction vector of the varnish layer, to obtain a second fusion result; fuse the first normal vector and the light source direction vector of the varnish layer, to obtain a third fusion result; determine a visibility of the varnish layer in a line-of-sight direction and a visibility of the varnish layer in a light source direction based on the roughness factor, the second fusion result, and the third fusion result; and determine the visibility of the varnish layer based on the visibility in the line-of-sight direction and the visibility in the light source direction.

In some embodiments, the visibility determining unit is further configured to: determine a second difference between the initial factor and the roughness factor; determine a third product of the second difference and the second fusion result, and determine a fourth product of the third product and the roughness factor; determine a product of the fourth product and the third fusion result, to obtain the visibility of the varnish layer in the line-of-sight direction; and determine the visibility of the varnish layer in the light source direction based on the roughness factor, the second difference, the second fusion result, and the third fusion result.

In some embodiments, the visibility determining unit is further configured to: determine a fifth product of the second difference and the third fusion result; determine a sixth product of the roughness factor and the fifth product; and determine a product of the sixth product and the second fusion result, to obtain the visibility of the varnish layer in the light source direction.

In some embodiments, the first highlight value determining unit is further configured to: determine a reflectivity of the varnish layer based on the reflection roughness, the visibility, and a first Fresnel factor of the varnish layer; and determine the first highlight value of the varnish layer under the direct light source based on the reflectivity of the varnish layer and the reflection intensity of the varnish layer.

In some embodiments, the light source includes a direct light source, and the exterior surface layer processing module 1403 includes a reflection value determining unit, a second Fresnel factor determining unit, and a second highlight value determining unit.

The reflection value determining unit is configured to determine, based on the original reflection value, the transmittance, and the reflection intensity of the varnish layer, a reflection value of the exterior surface layer for reflecting direct transmission light, the direct transmission light being light that is emitted by the direct light source and that is transmitted through the varnish layer.

The second Fresnel factor determining unit is configured to determine a second Fresnel factor of the exterior surface layer based on a second line-of-sight direction vector of the exterior surface layer, a second half-way vector, and a reflectivity corresponding to a second normal vector.

The second highlight value determining unit is configured to determine, based on the transmittance and the second Fresnel factor, the second highlight value generated on the exterior surface layer by the direct transmission light.

In some embodiments, the reflection value determining unit is further configured to: determine a candidate reflection value of the exterior surface layer based on the original reflection value, the transmittance, and the initial Fresnel value; and perform interpolation on the original reflection value and the candidate reflection value based on the reflection intensity of the varnish layer, to obtain the reflection value of the exterior surface layer for reflecting the direct transmission light.

In some embodiments, the second Fresnel factor determining unit is further configured to: fuse the second line-of-sight direction vector and the second half-way vector of the exterior surface layer, to obtain a fourth fusion result; and determine the second Fresnel factor of the exterior surface layer based on the fourth fusion result and the reflectivity corresponding to the second normal vector.

In some embodiments, the exterior rendering apparatus for a virtual object further includes: a transmittance determining module, configured to: obtain a color pixel value, a metalness, and a thickness of the varnish layer; determine, based on the thickness, the first normal vector of the varnish layer, the first line-of-sight direction vector, and the light source direction vector of the direct light source, a path distance for light emitted by the direct light source to penetrate the varnish layer; determine an extinction factor based on the color pixel value; determine a light depth based on the extinction factor, the thickness, and the path distance; and determine the transmittance of the varnish layer based on the light depth and the extinction factor.

In some embodiments, the exterior rendering apparatus for a virtual object further includes: an indirect light source processing module, configured to: determine a third highlight value of the varnish layer under an indirect light source based on the varnish layer roughness and an ambient light map of an environment in which the virtual object is located; and determine, based on an exterior surface layer roughness of the virtual object and the ambient light map, a fourth highlight value generated on the exterior surface layer by indirect transmission light, the indirect transmission light being light that is emitted by the indirect light source and that is transmitted through the varnish layer.

Correspondingly, the target illumination value determining module 1404 is configured to determine the target illumination value based on the first highlight value, the reflection value, the second highlight value, the third highlight value, and the fourth highlight value.

In some embodiments, the indirect light source processing module includes: a third highlight value determining unit, configured to: determine a first color pixel value of the varnish layer in the ambient light map of the environment in which the virtual object is located based on the varnish layer roughness, the first normal vector of the varnish layer, and the first line-of-sight direction vector; and determine the third highlight value of the varnish layer under the indirect light source based on the first color pixel value, an indirect light source reflectivity of the varnish layer, a light intensity of the indirect light source, and the first Fresnel factor of the varnish layer.

In some embodiments, the indirect light source processing module further includes: an edge adjustment factor determining module, configured to determine an edge adjustment factor based on the first Fresnel factor. The third highlight value determining unit is further configured to determine the third highlight value of the varnish layer under the indirect light source based on the first color pixel value, the indirect light source reflectivity of the varnish layer, the light intensity of the indirect light source, the first Fresnel factor of the varnish layer, and the edge adjustment factor.

In some embodiments, the indirect light source processing module includes: a fourth highlight value determining unit, configured to: obtain a second color pixel value of the exterior surface layer in the ambient light map based on the exterior surface layer roughness of the virtual object and the second line-of-sight direction vector and the second normal vector of the exterior surface layer; and determine, based on the second color pixel value, the indirect light source reflectivity of the exterior surface layer, the light intensity of the indirect light source, and the second Fresnel factor of the exterior surface layer, the fourth highlight value generated on the exterior surface layer by the indirect transmission light.

In some embodiments, the target illumination value determining module 1404 is further configured to: determine an illumination value of a to-be-rendered position on the varnish layer based on the first highlight value and the third highlight value; determine an illumination value of the to-be-rendered position on the exterior surface layer based on the reflection value, the second highlight value, and the fourth highlight value; and determine the target illumination value of the to-be-rendered position based on an illumination value of the to-be-rendered position on the varnish layer and the illumination value of the to-be-rendered position on the exterior surface layer.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

All or some of the modules in the foregoing exterior rendering apparatus for a virtual object may be implemented by a software, a hardware, or a combination thereof. The foregoing modules may be built in or independent of a processor of a computer device in a form of hardware, or may be stored in a memory of the computer device in a form of software, for invoke by the processor to execute the operations corresponding to the foregoing modules.

In an embodiment, a computer device is provided. The computer device may be a terminal, and an internal structure diagram of the computer device may be shown in FIG. 15. The computer device includes a processor, a memory, an input/output interface, a communication interface, a display unit, and an input apparatus. The processor, the memory, and the input/output interface are connected through a system bus. The communication interface, the display unit, and the input apparatus are connected to the system bus through the input/output interface. The processor of the computer device is configured to provide computing and control capabilities. The memory of the computer device includes a non-volatile storage medium and an internal memory. The non-volatile storage medium has an operating system and a computer program stored therein. The internal memory provides an environment for running of the operating system and the computer program in the non-volatile storage medium. The input/output interface of the computer device is configured for information exchange between the processor and an external device. The communication interface of the computer device is configured to perform wired or wireless communication with an external terminal. The wireless communication may be implemented through Wi-Fi, a mobile cellular network, near field communication (NFC), or another technology. The computer program, when executed by the processor, implements an exterior rendering method for a virtual object. The display unit of the computer device is configured to form a visible picture, and may be a display screen, a projection apparatus, or a virtual reality imaging apparatus. The display screen may be a liquid crystal display screen or an electronic ink display screen. The input apparatus of the computer device may be a touch layer covering the display screen, or may be a button, a trackball, or a touchpad arranged on a housing of the computer device, or may be an external keyboard, a touchpad, a mouse, or the like.

A person skilled in the art may understand that the structure shown in FIG. 15 is merely a block diagram of an example partial structure related to the solution of this disclosure, and does not constitute a limitation on the computer device to which the solution of this disclosure is applied. Specifically, the computer device may include more or fewer components than those shown in the figure, or some merged components, or different component arrangements.

In an embodiment, a computer device is provided, including a memory and one or more processors. The memory has computer-readable instructions stored therein, the computer-readable instructions, when executed by the processors, causing the one or more processors to perform the foregoing exterior rendering method for a virtual object.

In an embodiment, one or more non-volatile readable storage media are provided, having computer-readable instructions stored therein, the computer-readable instructions, when executed by one or more processors, causing the one or more processors to implement the foregoing exterior rendering method for a virtual object.

In an embodiment, a computer program product is provided, including a computer program, the computer program including computer-readable instructions, the computer-readable instructions, when executed by the processors, implementing the foregoing exterior rendering method for a virtual object.

A person of ordinary skill in the art may understand that all or some of the processes of the methods of the foregoing embodiments may be implemented by a computer program instructing relevant hardware. The computer program may be stored in a non-volatile computer-readable storage medium. When the computer program is executed, the processes of the foregoing method embodiments may be implemented. Any reference to a memory, a database, or another medium used in the embodiments provided in this disclosure may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a RAM, an external cache, or the like. As an illustration rather than a limitation, the RAM is available in various forms, such as a static random access memory (SRAM) or a dynamic random access memory (DRAM). The database involved in the embodiments provided in this disclosure may include at least one of a relational database and a non-relational database. The non-relational database may include a blockchain-based distributed database, or the like, but is not limited thereto. The processor involved in the embodiments provided in this disclosure is an example of processing circuitry and may be a general-purpose processor, a central processing unit, a graphics processing unit, a digital signal processor, a programmable logic device, a quantum computing-based data processing logic device, but is not limited thereto.

The technical features of the foregoing embodiments may be combined in different manners. To make the description concise, not all possible combinations of the technical features in the foregoing embodiments are described. However, the combinations of these technical features are considered to fall within the scope recorded in this disclosure provided that no conflict exists.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing embodiments merely show some implementations of this disclosure, and should not be construed as a limitation on the scope of this disclosure. A person of ordinary skill in the art may make transformations and improvements without departing from the concept of this disclosure. These transformations and improvements fall within the scope of this disclosure.

What is claimed is:

1. An exterior rendering method for a virtual object, the method comprising:
determining a first specular value of a clear coat layer of the virtual object under a light source, the clear coat layer covering an exterior surface of the virtual object;
obtaining an original reflection value of the exterior surface and a transmittance of the clear coat layer;
determining a reflection value and a second specular value of the exterior surface under the light source based on the original reflection value and the transmittance;
determining a target illumination value based on the first specular value, the reflection value, and the second specular value; and
performing illumination rendering on an exterior of the virtual object based on the target illumination value.

2. The method according to claim 1, wherein the light source is a direct light source, and the determining the first specular value comprises:
determining a reflection roughness of the clear coat layer based on a clear coat layer roughness of the virtual object and a first normal vector and a first half-way vector of the clear coat layer;
determining a visibility of the clear coat layer based on the clear coat layer roughness, the first normal vector, a first line-of-sight direction vector of the clear coat layer, and a light source direction vector of the direct light source; and
determining a first s value of the clear coat layer under the direct light source based on the reflection roughness, the visibility, and a reflection intensity of the clear coat layer.

3. The method according to claim 2, wherein the determining the reflection roughness of the clear coat layer comprises:
determining a roughness factor based on the clear coat layer roughness of the virtual object;
fusing the first normal vector and the first half-way vector of the clear coat layer, to obtain a first fusion result; and
determining the reflection roughness of the clear coat layer based on the roughness factor and the first fusion result.

4. The method according to claim 3, wherein the determining the visibility of the clear coat layer comprises:
determining the roughness factor based on the clear coat layer roughness of the virtual object;
fusing the first normal vector and the first line-of-sight direction vector of the clear coat layer, to obtain a second fusion result;
fusing the first normal vector and the light source direction vector of the direct light source, to obtain a third fusion result;
determining a visibility of the clear coat layer in a line-of-sight direction and a visibility of the clear coat layer in a light source direction based on the roughness factor, the second fusion result, and the third fusion result; and
determining the visibility of the clear coat layer based on the visibility in the line-of-sight direction and the visibility in the light source direction.

5. The method according to claim 4, further comprising:
determining a second difference between an initial factor and the roughness factor;
determining a third product of the second difference and the second fusion result;
determining a fourth product of the third product and the roughness factor, wherein
the determining the visibility of the clear coat layer in the line-of-sight direction includes determining a product of the fourth product and the third fusion result; and
the determining the visibility of the clear coat layer in the light source direction includes determining the visibility of the clear coat layer in the light source direction based on the roughness factor, the second difference, the second fusion result, and the third fusion result.

6. The method according to claim 5, wherein the determining the visibility of the clear coat layer in the light source direction comprises:
determining a fifth product of the second difference and the third fusion result;
determining a sixth product of the roughness factor and the fifth product; and
determining a product of the sixth product and the second fusion result, to obtain the visibility of the clear coat layer in the light source direction.

7. The method according to claim 2, wherein the determining the first specular value of the clear coat layer comprises:
determining a reflectivity of the clear coat layer based on the reflection roughness, the visibility, and a first Fresnel factor of the clear coat layer; and
determining the first specular value of the clear coat layer under the direct light source based on the reflectivity of the clear coat layer and the reflection intensity of the clear coat layer.

8. The method according to claim 1, wherein
the light source includes a direct light source;
the determining the reflection value includes determining, based on the original reflection value, the transmittance, and a reflection intensity of the clear coat layer, the reflection value of the exterior surface for reflecting direct transmission light, the direct transmission light being light that is emitted by the direct light source and that is transmitted through the clear coat layer; and
the determining the second specular value comprises:
determining a second Fresnel factor of the exterior surface based on a second line-of-sight direction vector of the exterior surface, a second half-way vector, and a reflectivity corresponding to a second normal vector; and
determining, based on the transmittance and the second Fresnel factor, the second specular value generated on the exterior surface by the direct transmission light.

9. The method according to claim 8, wherein the determining the reflection value of the exterior surface comprises:
determining a candidate reflection value of the exterior surface based on the original reflection value, the transmittance, and an initial Fresnel value; and
performing interpolation on the original reflection value and the candidate reflection value based on the reflection intensity of the clear coat layer, to obtain the reflection value of the exterior surface for reflecting the direct transmission light.

10. The method according to claim 8, wherein the determining the second Fresnel factor of the exterior surface comprises:
fusing the second line-of-sight direction vector and the second half-way vector of the exterior surface, to obtain a fourth fusion result; and
determining the second Fresnel factor of the exterior surface based on the fourth fusion result and the reflectivity corresponding to the second normal vector.

11. The method according to claim 2, further comprising:
obtaining a color pixel value, a metalness, and a thickness of the clear coat layer;
determining, based on the thickness, the first normal vector of the clear coat layer, the first line-of-sight direction vector, and the light source direction vector of the direct light source, a path distance for light emitted by the direct light source to penetrate the clear coat layer;
determining an extinction factor based on the color pixel value;
determining a light depth based on the extinction factor, the thickness, and the path distance; and
determining the transmittance of the clear coat layer based on the light depth and the extinction factor.

12. The method according to claim 1, further comprising:
determining a third specular value of the clear coat layer under an indirect light source based on a clear coat layer roughness and an ambient light map of an environment in which the virtual object is located; and
determining, based on an exterior surface roughness of the virtual object and the ambient light map, a fourth specular value generated on the exterior surface by indirect transmission light, the indirect transmission light being light that is emitted by the indirect light source and that is transmitted through the clear coat layer, wherein
the determining the target illumination value includes determining the target illumination value based on the first specular value, the reflection value, the second specular value, the third specular value, and the fourth specular value.

13. The method according to claim 12, wherein the determining the third specular value comprises:
determining a first color pixel value of the clear coat layer in the ambient light map of the environment in which the virtual object is located based on the clear coat layer roughness, a first normal vector of the clear coat layer, and a first line-of-sight direction vector; and
determining the third specular value of the clear coat layer under the indirect light source based on the first color pixel value, an indirect light source reflectivity of the clear coat layer, a light intensity of the indirect light source, and a first Fresnel factor of the clear coat layer.

14. The method according to claim 13, further comprising:
determining an edge adjustment factor based on the first Fresnel factor, wherein
the determining the third specular value of the clear coat layer includes determining the third specular value of the clear coat layer under the indirect light source based on the first color pixel value, the indirect light source reflectivity of the clear coat layer, the light intensity of the indirect light source, the first Fresnel factor of the clear coat layer, and the edge adjustment factor.

15. The method according to claim 12, wherein the determining the fourth specular value comprises:
obtaining a second color pixel value of the exterior surface in the ambient light map based on the exterior surface roughness of the virtual object and a second line-of-sight direction vector and a second normal vector of the exterior surface; and
determining, based on the second color pixel value, the indirect light source reflectivity of the exterior surface, a light intensity of the indirect light source, and a second Fresnel factor of the exterior surface, the fourth specular value generated on the exterior surface by the indirect transmission light.

16. The method according to claim 12, wherein the determining the target illumination value comprises:
determining an illumination value of a to-be-rendered position on the clear coat layer based on the first specular value and the third specular value;
determining an illumination value of the to-be-rendered position on the exterior surface based on the reflection value, the second specular value, and the fourth specular value; and
determining the target illumination value of the to-be-rendered position based on an illumination value of the to-be-rendered position on the clear coat layer and the illumination value of the to-be-rendered position on the exterior surface.

17. An information processing apparatus, comprising:
processing circuitry configured to:
determine a first specular value of a clear coat layer of a virtual object under a light source, the clear coat layer covering an exterior surface of the virtual object;
obtain an original reflection value of the exterior surface and a transmittance of the clear coat layer;
determine a reflection value and a second specular value of the exterior surface under the light source based on the original reflection value and the transmittance;
determine a target illumination value based on the first specular value, the reflection value, and the second specular value; and
perform illumination rendering on an exterior of the virtual object based on the target illumination value.

18. The information processing apparatus according to claim 17, wherein the light source is a direct light source, and the processing circuitry is configured to:
determine a reflection roughness of the clear coat layer based on a clear coat layer roughness of the virtual object and a first normal vector and a first half-way vector of the clear coat layer;
determine a visibility of the clear coat layer based on the clear coat layer roughness, the first normal vector, a first line-of-sight direction vector of the clear coat layer, and a light source direction vector of the direct light source; and
determine a first s value of the clear coat layer under the direct light source based on the reflection roughness, the visibility, and a reflection intensity of the clear coat layer.

19. The information processing apparatus according to claim 18, wherein the processing circuitry is configured to:
determine a roughness factor based on the clear coat layer roughness of the virtual object;
fuse the first normal vector and the first half-way vector of the clear coat layer, to obtain a first fusion result; and
determine the reflection roughness of the clear coat layer based on the roughness factor and the first fusion result.

20. At least one non-transitory computer-readable storage medium storing instructions which when executed by at least one processor cause the at least one processor to perform:
determining a first specular value of a clear coat layer of a virtual object under a light source, the clear coat layer covering an exterior surface of the virtual object;
obtaining an original reflection value of the exterior surface and a transmittance of the clear coat layer;
determining a reflection value and a second specular value of the exterior surface under the light source based on the original reflection value and the transmittance;
determining a target illumination value based on the first specular value, the reflection value, and the second specular value; and
performing illumination rendering on an exterior of the virtual object based on the target illumination value.
